(19) United States
(12) Patent Application Publication
(10) Pub. No.: US 2008/0034140 A1
(43) Pub. Date: Feb. 7, 2008

(54) Bus Arbitrating Device and Bus Arbitrating Method

(76) Inventor: Koji Kai, Fukuoka (JP)

Correspondence Address: WENDEROTH, LIND & PONACK L.L.P., 2033 K. STREET, NW, SUITE 800, WASHINGTON, DC, 20006, US

(21) Appl. No.: 11/579,913

(22) PCT Filed: Jun. 15, 2005
(86) PCT No.: PCT/JP05/10914

§ 371 Date: Nov. 8, 2006

(30) Foreign Application Priority Data
Jun. 16, 2004 (JP) 2004-178045

(51) Int. Cl. G06F 13/368

(52) U.S. Cl. 710/119

(57) ABSTRACT

A bus arbitrating device (100) arbitrates the data transfer request for a plurality of bus-master (11)-(13) connected to a bus (10), and comprises a bus assignment deciding unit (20) and a measurement control unit (30). The measurement control unit (30) includes a time counter (31), a comparator (32), and a timer register (33). The comparator (32) compares a system operating time measured by the time counter (31), with a time period set in the timer register (33). When the system operating time exceeds the time period, the comparator (32) notifies the bus assignment deciding unit (20) of the fact. The bus assignment deciding unit (20) chooses one from a plurality of bus arbitration algorithms as a new bus arbitration algorithm, and arbitrates the bus. Consequently, the deviation of the right of bus use of each bus master can be avoided.

### TECHNICAL FIELD

The present invention relates to the bus arbitrating device and bus arbitrating method which are used by the multiprocessor LSI possessing a plurality of bus masters connected to a bus, in particular, to optimization of the bus arbitration to a bus request from each bus master.

### BACKGROUND ART

Generally, to a bus request from each bus master, one bus arbitrating device operates so that a right of bus use may be preferentially granted according to the priority prescribed for every bus master, while another bus arbitrating device operates so that a right of bus use may be equally granted to each bus master. Here, a bus master is defined as one of various processors, CPU's, etc., which accesses a bus by itself, and transfers data to and from memories.

An arbitrating system which grants a right of bus use according to the priority set in advance is commonly known as a fixed-priority scheduling.

On the other hand, there are several systems which grant a right of bus use equally to each bus master. A document 1 (Published Japanese patent application Hei 3-142651) discloses the technology about the bus arbitrating device which is designed so that the data transfer amount for each bus master may become equal. FIG. 16 is a block diagram illustrating a bus arbitrating device according to the conventional art. The figure shows the main part of the block diagram of the bus arbitrating device disclosed by the document 1. In the bus arbitrating device, devices 1-n, connected to a bus 4, comprise arbiters 1a-na and transfer counters 1t-nt, respectively. The devices 1-n correspond to bus masters, and the arbiters 1a-na correspond to bus arbitrating devices.

The transfer counters 1t-nt measure the accumulation of the data amount which the corresponding devices 1-n transfer. Each of the arbiters 1a-na behaves to decrease the priority of the right of bus use of a device for which the accumulation of the data transfer amount is great. In this way, the data transfer amount for each device is kept to be uniform.

Moreover, a document 2 (Published Japanese patent application Hei 6-309274) discloses a method which employs a random code generator to grant a right of bus use at random, thereby distributing the right of bus use pseudo-uniformly.

However, when the bus arbitrating device disclosed by the document 1 is applied to the system in which data transfer amount differs among bus masters, processing of a bus master originally possessing much amount of data to be transferred tends to be overdue, because the right of bus use is equally granted to each bus master. Consequently, there arises a problem that a system-wide processing efficiency decreases. To be specific, when a bus master possessing much data transfer amount and a bus master possessing a little data transfer amount exist together, the priority of the bus master possessing much data transfer amount is made low. Consequently, there arises a problem that data transfer cannot complete within a predetermined time.

Moreover, when the bus arbitration by a fixed priority order is applied, the priority of a bus master possessing much data transfer amount is made high and the priority of a bus master possessing a little data transfer amount is made low; as a result, the bus master possessing a little data transfer amount can hardly use the bus. Consequently, there arises an issue that processing gets delayed in the whole system.

### DISCLOSURE OF THE INVENTION

In view of the above, an object of the present invention is to provide a bus arbitrating device and method which, in a system possessing a bus and a plurality of bus masters connected to the bus, can adaptively change the priority in bus use of each bus master, thereby attaining optimization of the bus arbitration to the bus request from each bus master.

A first aspect of the present invention provides a bus arbitrating device operable to arbitrate data transfer requests in a system including a bas and a plurality of bus masters which are connected to the bus and issue the data transfer requests, the bus arbitrating device comprising: a measurement control unit operable to measure bus arbitration judgment amount; and a bus assignment deciding unit operable to arbitrate data transfer requests among the plurality of bus masters, based on a predetermined bus arbitration algorithm. The measurement control unit measures, as the bus arbitration judgment amount, at least one of: system operating time of the system; accumulated data transfer amount indicative of each accumulation of data amount transferred by each of the plurality of bus masters; and necessary data transfer time indicative of time consumed in data transfer by each of the plurality of bus masters. The measurement control unit generates control information when the measured bus arbitration judgment amount satisfies a prescribed condition, thereby notifying the bus assignment deciding unit of the generated control information, and the bus assignment deciding unit changes the bus arbitration algorithm based on the notified control information, thereby performing new bus arbitration.

According to the structure, it becomes possible to change the priority of the bus access right to each bus master, every time when the system operating time goes through the predetermined time period, every time when the accumulated data transfer amount exceeds the reference data transfer amount, or, every time when the necessary data transfer time exceeds the reference data transfer time. Therefore, the deviation of the right of bus use depending on a bus arbitration algorithm is mitigated, and preferred bus arbitration can be performed.

A second aspect of the present invention provides the bus arbitrating device as defined in the first aspect, wherein the measurement control unit comprises: a timing unit operable to measure the system operating time as the bus arbitration judgment amount; a time period setting unit operable to set a time period corresponding to a prescribed time; and a comparing unit operable to compare the system operating time with the time period. The comparing unit generates, as the control information, information indicative that the prescribed time has elapsed, every time when the system operating time passes the time period, thereby notifying the bus assignment deciding unit of the generated control information, and the bus assignment deciding unit changes the bus arbitration algorithm based on the notified control information, thereby performing new bus arbitration.

According to the structure, it becomes possible to change the priority of the bus access right to each bus master, every time when the predetermined time period passes by; consequently, the deviation of the right of bus use depending on the bus arbitration algorithm can be mitigated.

A third aspect of the present invention provides the bus arbitrating device as defined in the second aspect, wherein the bus assignment deciding unit selects, based on the notified control information, one of a plurality of bus arbitration algorithms prepared in advance, thereby performing new bus arbitration using the selected bus arbitration algorithm.

According to the structure, a plurality of bus arbitration algorithms may be set beforehand and one of them is chosen to change the bus arbitration algorithm, every time when the predetermined time period passes by.

A fourth aspect of the present invention provides the bus arbitrating device as defined in the third aspect, wherein the bus arbitration algorithm selected by the bus assignment deciding unit is a fixed-priority scheduling.

According to the structure, the system user can set up the priority of the bus use of each bus master in advance; thereby, the simple and fixed bus arbitration is realizable, based on the predetermined priority.

A fifth aspect of the present invention provides the bus arbitrating device as defined in the third aspect, wherein the bus arbitration algorithm selected by the bus assignment deciding unit is a round-robin scheduling.

According to the structure, the right of bus use of each bus master can be changed cyclically.

A sixth aspect of the present invention provides the bus arbitrating device as defined in the first aspect, wherein the measurement control unit comprises: a plurality of data transfer amount measuring units operable to measure, as the bus arbitration judgment amount, accumulated data transfer amount indicative of each accumulation of data amount transferred by each of the plurality of bus masters; a plurality of data transfer amount setting units operable to set reference data transfer amount predetermined for each of the plurality of bus masters; and a plurality of comparing units operable to compare the accumulated data transfer amount with the reference data transfer amount for each of the plurality of bus masters. The plurality of comparing units generate, as the control information, information indicative that the prescribed data amount has been transferred, every time when the accumulated data transfer amount reaches the reference data transfer amount, thereby notifying the bus assignment deciding unit of the generated control information, and the bus assignment deciding unit changes the bus arbitration algorithm based on the notified control information, thereby performing new bus arbitration.

According to the structure, when the data transfer amount within a definite period of time exceeds the predetermined data transfer amount, the bus arbitration algorithm will be changed to perform new bus arbitration. Therefore, it becomes possible to change the priority of the bus access right to a bus master, depending on degree of the data transfer amount.

A seventh aspect of the present invention provides the bus arbitrating device as defined in the sixth aspect, wherein each of the plurality of data transfer amount measuring units, each of the plurality of data transfer amount setting units and each of the plurality of comparing units are respectively installed, corresponding to each of the plurality of bus masters, in a one-to-one correspondence manner.

According to the structure, it is possible to perform, for every bus master, the measurement of the data transfer amount and the setup of the reference data transfer amount. Therefore, the bus arbitration adaptive to the situation of each bus master becomes realizable.

An eighth aspect of the present invention provides the bus arbitrating device as defined in the sixth aspect, wherein the bus assignment deciding unit selects, based on the notified control information, one of a plurality of bus arbitration algorithms prepared in advance, thereby performing new bus arbitration using the selected bus arbitration algorithm.

According to the structure, a plurality of bus arbitration algorithms are provided in advance and one of them is chosen to change the bus arbitration algorithm, when the data transfer amount within a definite period of time exceeds the predetermined data transfer amount.

A ninth aspect of the present invention provides the bus arbitrating device as defined in the eighth aspect, wherein the bus arbitration algorithm selected by the bus assignment deciding unit is a fixed-priority scheduling.

According to the structure, the system user can set up the priority of the bus use of each bus master in advance; thereby, the simple and fixed bus arbitration is realizable, based on the predetermined priority.

A tenth aspect of the present invention provides the bus arbitrating device as defined in the eighth aspect, wherein, when the bus assignment deciding unit selects the fixed-priority scheduling as the bus arbitration algorithm, the bus assignment deciding unit, based on the notified control information, prohibits bus use by a bus master for which the accumulated data transfer amount has reached the reference data transfer amount, the bus master being one of the plurality of bus masters.

According to the structure, the bus use is forbidden for a bus master for which the accumulated data transfer amount reached the reference data transfer amount. By this scheme, it is possible to raise the priority in the bus use of the other bus masters for which the accumulated data transfer amount has not reached the reference data transfer amount.

An eleventh aspect of the present invention provides the bus arbitrating device as defined in the eighth aspect, wherein, when the bus assignment deciding unit selects the fixed-priority scheduling as the bus arbitration algorithm, the bus assignment deciding unit, based on the notified control information, lowers the priority in bus use by a bus master for which the accumulated data transfer amount has reached the reference data transfer amount, the bus master being one of the plurality of bus masters.

According to the structure, the priority is lowered in the bus use of the bus master for which the accumulated data transfer amount reached the reference data transfer amount. By this scheme, it is possible to raise the priority in the bus use of the other bus masters for which the accumulated data transfer amount has not reached the reference data transfer amount.

A twelfth aspect of the present invention provides the bus arbitrating device as defined in the eighth aspect, wherein, when the bus assignment deciding unit selects the fixed-priority scheduling as the bus arbitration algorithm, the bus assignment deciding unit, based on the notified control information, raises the priority in bus use by a bus master for which the accumulated data transfer amount has reached the reference data transfer amount, the bus master being one of the plurality of bus masters.

According to the structure, it becomes possible to increase allocation of the right of bus use to a bus master possessing much data transfer amount, thereby further advancing the processing of a bus master which needs to transfer much data amount.

A thirteenth aspect of the present invention provides the bus arbitrating device as defined in the eighth aspect, wherein the bus arbitration algorithm selected by the bus assignment deciding unit is a round-robin scheduling.

According to the structure, the right of bus use of each bus master can be changed cyclically.

A fourteenth aspect of the present invention provides the bus arbitrating device as defined in the eighth aspect, wherein, when the bus assignment deciding unit selects the round-robin scheduling as the bus arbitration algorithm, the bus assignment deciding unit, based on the notified control information, prohibits bus use by a bus master for which the accumulated data transfer amount has reached the reference data transfer amount, the bus master being one of the plurality of bus masters.

According to the structure, the bus use is forbidden for a bus master for which the accumulated data transfer amount reached the reference data transfer amount. By this scheme, it is possible to cyclically permit the bus use of the other bus masters for which the accumulated data transfer amount has not reached the reference data transfer amount.

A fifteenth aspect of the present invention provides the bus arbitrating device as defined in the first aspect, wherein the measurement control unit comprising: a plurality of data transfer time measuring units operable to measure, as the bus arbitration judgment amount, necessary data transfer time indicative of time consumed in data transfer by each of the plurality of bus masters; a plurality of data transfer time setting units operable to set reference data transfer time predetermined for each of the plurality of bus masters; and a plurality of comparing units operable to compare the necessary data transfer time with the reference data transfer time for each of the plurality of bus masters. The plurality of comparing units generate, as the control information, information indicative that the prescribed data transfer time has been consumed, every time when the necessary data transfer time reaches the reference data transfer time, thereby notifying the bus assignment deciding unit of the generated control information, and the bus assignment deciding unit changes the bus arbitration algorithm based on the notified control information, thereby performing new bus arbitration.

According to the structure, when the data transfer time exceeds the predetermined data transfer time, the bus arbitration algorithm will be changed to perform new bus arbitration. Therefore, it becomes possible to change the priority of the bus access right to a bus master, depending on degree of bus occupying time.

A sixteenth aspect of the present invention provides the bus arbitrating device as defined in the fifteenth aspect, wherein each of the plurality of data transfer time measuring units, each of the plurality of data transfer time setting units and each of the plurality of comparing units are respectively installed, corresponding to each of the plurality of bus masters in a one-to-one correspondence manner.

According to the structure, it is possible to perform the measurement of the data transfer time and the setup of the reference data transfer time, for every bus master.

Therefore, the bus arbitration adaptive to the situation of each bus master becomes possible.

A seventeenth aspect of the present invention provides the bus arbitrating device as defined in the fifteenth aspect, wherein the bus assignment deciding unit selects, based on the notified control information, one of a plurality of bus arbitration algorithms prepared in advance, thereby performing new bus arbitration with the selected bus arbitration algorithm.

According to the structure, a plurality of bus arbitration algorithms are provided in advance and one of them is chosen to change the bus arbitration algorithm, when the data transfer time reaches the reference data transfer time in any one of a plurality of bus masters.

An eighteenth aspect of the present invention provides the bus arbitrating device as defined in the fourteenth aspect, wherein the bus arbitration algorithm selected by the bus assignment deciding unit is a fixed-priority scheduling.

According to the structure, the system user can set up the priority of the bus use of each bus master in advance; thereby, the simple and fixed bus arbitration is realizable, based on the predetermined priority.

A nineteenth aspect of the present invention provides the bus arbitrating device as defined in the seventeenth aspect, wherein, when the bus assignment deciding unit selects the fixed-priority scheduling as the bus arbitration algorithm, the bus assignment deciding unit, based on the notified control information, prohibits bus use by a bus master for which the necessary data transfer time has reached the reference data transfer time, the bus master being one of the plurality of bus masters.

According to the structure, the bus use of a bus master for which the data transfer time reached the reference data transfer time is forbidden. By this scheme, it is possible to raise the priority in the bus use of the other bus masters for which the data transfer time has not reached the reference data transfer time.

A twentieth aspect of the present invention provides the bus arbitrating device as defined in the seventeenth aspect, wherein, when the bus assignment deciding unit selects the fixed-priority scheduling as the bus arbitration algorithm, the bus assignment deciding unit, based on the notified control information, lowers the priority in bus use by a bus master for which the necessary data transfer time has reached the reference data transfer time, the bus master being one of the plurality of bus masters.

According to the structure, it becomes possible to lower the priority in the bus use of the bus master which uses the bus more often, thereby allowing balanced bus use in the whole system.

A twenty-first aspect of the present invention provides the bus arbitrating device as defined in the seventeenth aspect, wherein, when the bus assignment deciding unit selects the fixed-priority scheduling as the bus arbitration algorithm, the bus assignment deciding unit, based on the notified control information, raises the priority in bus use by a bus master for which the necessary data transfer time has reached the reference data transfer time, the bus master being one of the plurality of bus masters.

According to the structure, it becomes possible to increase allocation of the right of bus use to a bus master which uses the bus more frequently, thereby further advancing the processing of a bus master which needs to transfer much data amount.

A twenty-second aspect of the present invention provides the bus arbitrating device as defined in the seventeenth aspect, wherein the bus arbitration algorithm selected by the bus assignment deciding unit is a round-robin scheduling.

According to the structure, the right of bus use of each bus master can be changed cyclically.

A twenty-third aspect of the present invention provides the bus arbitrating device as defined in the seventeenth aspect, wherein, when the bus assignment deciding unit selects the round-robin scheduling as the bus arbitration algorithm, the bus assignment deciding unit, based on the notified control information, prohibits bus use by a bus master for which the necessary data transfer time has reached the reference data transfer time, the bus master being one of the plurality of bus masters.

According to the structure, the bus use of a bus master for which the data transfer time reached the reference data transfer time is forbidden. By this scheme, it is possible to cyclically permit the bus use of the other bus masters for which the data transfer time has not reached the reference data transfer time.

A twenty-fourth aspect of the present invention provides a bus arbitrating method for arbitrating data transfer requests in a system including a bus and a plurality of bus masters which are connected to the bus and issue the data transfer requests, the bus arbitrating method comprising: a measurement control step of measuring bus arbitration judgment amount; and a bus assignment deciding step of arbitrating data transfer requests among the plurality of bus masters, based on a predetermined bus arbitration algorithm. The measurement control step includes measuring, as the bus arbitration judgment amount, at least one of: system operating time of the system; accumulated data transfer amount indicative of each accumulation of data amount transferred by each of the plurality of bus masters; and necessary data transfer time indicative of time consumed in data transfer by each of the plurality of bus masters. The measurement control step further includes generating control information when the measured bus arbitration judgment amount satisfies a prescribed condition. The bus assignment deciding step includes changing the bus arbitration algorithm, based on the control information generated in the measurement control step, thereby performing new bus arbitration.

According to the method, every time when the system time passes the predetermined time period, every time when the accumulated data transfer amount exceeds the reference data transfer amount, or every time when the necessary data transfer time exceeds the reference data transfer time, it becomes possible to change the priority of the bus access right to each bus master. Consequently, the deviation of the right of bus use due to the bus arbitration algorithm is mitigated, and preferred bus arbitration can be performed.

A twenty-fifth aspect of the present invention provides the bus arbitrating method as defined in the twenty-fourth aspect, wherein the measurement control step comprises: a timing step of timing the system operating time as the bus arbitration judgment amount; a time period setting step of setting a time period corresponding to a prescribed time; and a comparing step of comparing the system operating time with the time period. The comparing step includes generating, as the control information, information indicative that the prescribed time has elapsed, every time when the system operating time passes the time period, and the bus assignment deciding step includes changing the bus arbitration algorithm, based on the control information generated in the comparing step, thereby performing new bus arbitration.

According to the method, it becomes possible to change the priority of the bus access right to each bus master, every time when the predetermined time period passes by; consequently, the deviation of the right of bus use depending on the bus arbitration algorithm can be mitigated.

A twenty-seventh aspect of the present invention provides the bus arbitrating method as defined in the twenty-fourth aspect, wherein the measurement control step comprises: a data transfer amount measuring step of measuring accumulated data transfer amount as the bus arbitration judgment amount, the accumulated data transfer amount being each accumulation of data amount transferred by each of the plurality of bus masters; a data transfer amount setting step of setting reference data transfer amount predetermined for each of the plurality of bus masters; and a comparing step of comparing the accumulated data transfer amount with the reference data transfer amount. The comparing step includes generating, as the control information, information indicative that the prescribed data amount has been transferred, every time when the accumulated data transfer amount reaches the reference data transfer amount. The bus assignment deciding step includes changing the bus arbitration algorithm, based on the control information generated in the comparing step, thereby performing new bus arbitration with the changed bus arbitration algorithm.

According to the method, when the data transfer amount within a definite period of time exceeds the predetermined data transfer amount, the bus arbitration algorithm will be changed to perform new bus arbitration. Therefore, it becomes possible to change the priority of the bus access right to a bus master, depending on degree of the data transfer amount.

A thirty-second aspect of the present invention provides the bus arbitrating method as defined in the twenty-fourth aspect, wherein the measurement control step comprises: a data transfer time measuring step of measuring necessary data transfer time indicative of time consumed in data transfer by each of the plurality of bus masters, as the bus arbitration judgment amount; a data transfer time setting step of setting reference data transfer time prescribed for each of the plurality of bus masters; and a comparing step of comparing the necessary data transfer time with the reference data transfer time for each of the plurality of bus masters. The comparing step includes generating, as the control information, information indicative that the prescribed data transfer time has been consumed, every time when the necessary data transfer time reaches the reference data transfer time, and the bus assignment deciding step includes changing the bus arbitration algorithm, based on the control information generated in the comparing step, thereby performing new bus arbitration with the changed bus arbitration algorithm.

According to the method, when the data transfer time exceeds the predetermined data transfer time, the bus arbitration algorithm will be changed to perform new bus arbitration. Therefore, it becomes possible to change the priority of the bus access right to a bus master, depending on degree of bus occupying time.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating a bus arbitrating device, and a layout drawing illustrating a bus arbitrating device and a plurality of bus masters, in Embodiment 1 of the present invention;

FIG. 2 is a block diagram illustrating a bus assignment deciding unit in Embodiment 1 of the present invention;

FIG. 3 is a block diagram illustrating a fixed-priority-scheduled arbitration circuit in Embodiment 1 of the present invention;

FIG. 4 is a block diagram illustrating a round-robin-scheduled arbitration circuit in Embodiment 1 of the present invention;

FIG. 5 is a block diagram illustrating a bus assignment deciding unit in Embodiment 1 of the present invention;

FIG. 6 is a block diagram illustrating a bus arbitrating device, and a layout drawing illustrating a bus arbitrating device and a plurality of bus masters, in Embodiment 2 of the present invention;

FIG. 7 is a block diagram illustrating a bus assignment deciding unit in Embodiment 2 of the present invention;

FIG. 8 is a block diagram illustrating a bus assignment deciding unit in Embodiment 2 of the present invention;

FIG. 9 is a block diagram illustrating a bus arbitrating device, and a layout drawing illustrating a bus arbitrating device and a plurality of bus masters, in Embodiment 3 of the present invention;

FIG. 10 is a flow chart for changes in bus arbitration algorithm in Embodiment 1 of the present invention;

FIG. 11 is a flow chart for changes in bus arbitration algorithm in Embodiment 2 of the present invention;

FIG. 12 is a flow chart for a bus assignment deciding unit in Embodiment 2 of the present invention;

FIG. 13 is a flow chart for a bus assignment deciding unit in Embodiment 2 of the present invention;

FIG. 14 is a flow chart for a bus assignment deciding unit in Embodiment 2 of the present invention;

FIG. 15 is a flow chart for bus-arbitration-algorithm change in Embodiment 3 of the present invention; and

FIG. 16 is a block diagram illustrating the bus arbitrating device in the conventional art.

### BEST MODE FOR CARRYING OUT THE INVENTION

Hereinafter, a description is given of embodiments of the invention with reference to the accompanying drawings.

### Embodiment 1

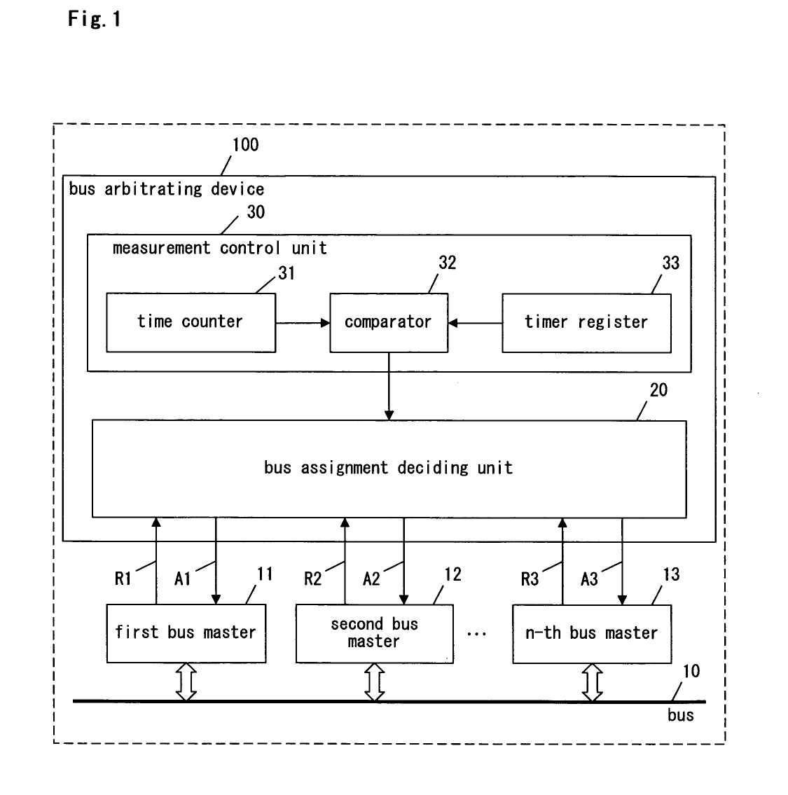

FIG. 1 is a block diagram illustrating a bus arbitrating device, and a layout drawing illustrating a bus arbitrating device and a plurality of bus masters, in Embodiment 1 of the present invention.

A bus arbitrating device 100 according to the present embodiment comprises a bus assignment deciding unit 20 and a measurement control unit 30. The measurement control unit 30 includes a time counter 31, a comparator 32, and a timer register 33. The bus arbitrating device 100 arbitrates the data transfer request for a plurality of bus masters connected to the bus 10 (a first bus master 11, a second bus master 12 . . . an n-th bus master 13 (“n” is a natural number greater than “1”. Hereinafter the definition of “n” is same as above.)).

The time counter 31 corresponds to a timing unit, and the timer register 33 corresponds to a time period setting unit.

To the bus arbitrating device 100, the first bus master 11 makes a request for use of the bus 10 by a bus request R1, the second bus master 12 makes a request for use of the bus 10 by a bus request R2, and the n-th bus master 13 makes a request for use of the bus 10 by a bus request R3.

When the bus-use request from each bus master is received, the bus arbitrating device 100 determines, according to the bus arbitration algorithm currently executed, the priority with which each bus master uses the bus 10, and the bus arbitrating device 100 issues the use permission of the bus 10 to each bus master.

Namely, the bus arbitrating device 100 issues the use permission of the bus 10 to the first bus master 11 by a bus reply A1, to the second bus master 12 by a bus reply A2, and to the n-th bus master 13 by a bus-reply A3.

The outline of operation of the bus arbitrating device 100 in change of the bus arbitration algorithm is explained according to FIG. 10, with concurrent reference to FIG. 1.

FIG. 10 is a flow chart for changes in bus arbitration algorithm in Embodiment 1 of the present invention.

Processing starts at Step S10.

In Step S11, a time period is set to the timer register 33 in the bus arbitrating device 100.

In Step S12, the time counter 31 is reset and in Step S13, the time counter 31 measures a system operating time.

In Step S14, the comparator 32 compares the system operating time which the time counter 31 measured in Step S13 with the time period set in the timer register 33 in Step S11. If the system operating time is less than the time period, and the comparison result is “No”, the control returns to Step S13 and the time counter 31 continues to measure the system operating time. When the system operating time passes the time period, and the comparison result is “Yes”, the control moves to Step S15.

In Step S15, the comparator 32 generates the control information which indicates that the system operating time has passed the time period, and the comparator 32 notifies the bus assignment deciding unit 20 of the generated control information.

In Step S16, the bus assignment deciding unit 20 changes the bus arbitration algorithm currently executed to a new bus arbitration algorithm to be executed.

In Step S17, it is judged whether a series of processing has completed. If the series of processing has not completed, the judgment result is “No”, and the control returns to Step S12, then the processing from Step S12 to the step S17 is repeated. If the series of processing has completed, the judgment result is “Yes”, and the control moves to Step S18 to end the processing.

In the change process of the bus arbitration algorithm of the present embodiment, until the bus arbitration algorithm is changed in Step S16, the bus assignment deciding unit 20, in response to the bus-use request from each bus master, determines the priority for which each bus master uses the bus 10, according to the bus arbitration algorithm under execution, and the bus assignment deciding unit 20 issues the use permission of the bus 10 to each bus master.

Specifically, the change of the bus arbitration algorithm is made as follows.

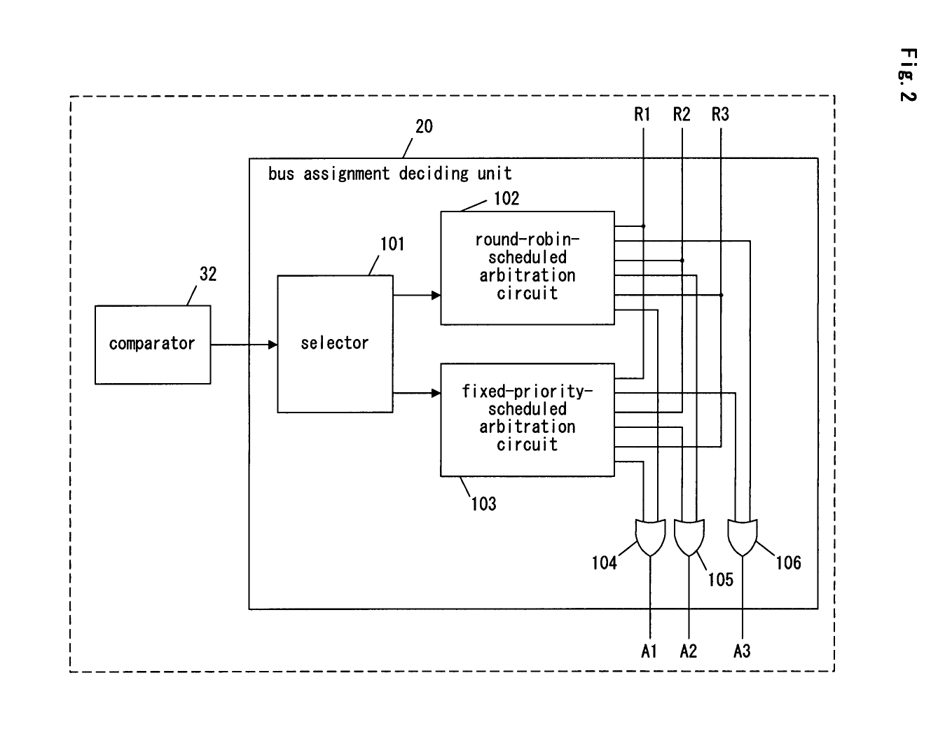

FIG. 2 is a block diagram illustrating a bus assignment deciding unit 20 in Embodiment 1 of the present invention. The bus assignment deciding unit 20 of the present embodiment executes the change of the bus arbitration algorithm by hardware. Namely, the bus assignment deciding unit 20 of the present embodiment includes a selector 101, a round-robin-scheduled arbitration circuit 102, a fixed-priority-scheduled arbitration circuit 103, and OR circuits 104, 105, and 106.

In the following, operation of the bus assignment deciding unit 20 of the present embodiment is explained. When the control information, indicating that the system operating time has passed the time period, is sent from the comparator 32 shown in FIG. 1, the selector 101 switches the round-robin-scheduled arbitration circuit 102 and the fixed-priority-scheduled arbitration circuit 103, based on the control information.

In the bus arbitration described above, the bus arbitration algorithm is realized by the hardware made of the arbitration circuits which are incorporated in the round-robin-scheduled arbitration circuit 102 and the fixed-priority-scheduled arbitration circuit 103.

When the fixed-priority-scheduled arbitration circuit 103 is chosen, the bus arbitration by fixed-priority scheduling is performed to bus requests R1, R2, and R3, and bus replies A1, A2, and A3 are issued. In this case, the priority over the bus requests R1, R2, and R3 is set by the system user in advance, and is fixed.

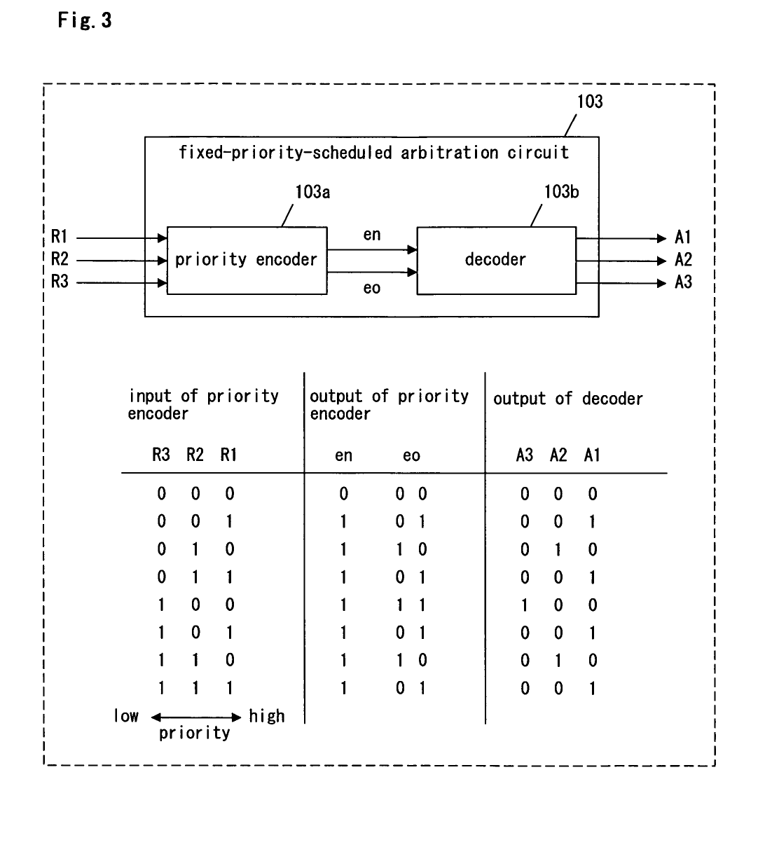

FIG. 3 is a block diagram illustrating a fixed-priority-scheduled arbitration circuit 103 in Embodiment 1 of the present invention. The fixed-priority-scheduled arbitration circuit 103 of the present embodiment includes a priority encoder 103a and a decoder 103b, and inputs bus requests R1, R2, and R3, and outputs bus replies A1, A2, and A3 after the bus arbitration.

In the present example, in response to the priority encoder input “R3R2R1” in 3 bits, the priority encoder 103a outputs the enabling output “en” and the encoder output “eo”, and the decoder 103b outputs the decoder output “A3A2A1” in 3 bits, according to the logic shown in the appended chart of FIG. 3. More specifically, in FIG. 3, the priority of each bus request is set so that the bus request R1 possesses the highest priority, the bus request R2 the next highest priority, and the bus request R3 the lower priority. For example, when the bus request R1 from the first bus master 11 and the bus request R2 from the second bus master 12 are issued simultaneously, i.e., (R1=1, R2=1, R3=0), then the decoder output is A1=1, A2=0, and A3=0; therefore, the bus reply A1 is issued, and the use permission of the bus 10 is given to the first bus master 11.

In this way, a high-speed bus-arbitration processing is realizable by the fixed-priority-scheduled arbitration circuit 103 shown in FIG. 3.

Moreover, when the round-robin-scheduled arbitration circuit 102 is chosen, the bus arbitration by a round-robin scheduling is performed to bus requests R1, R2, and R3, and bus replies A1 and A2 and A3 are issued cyclically.

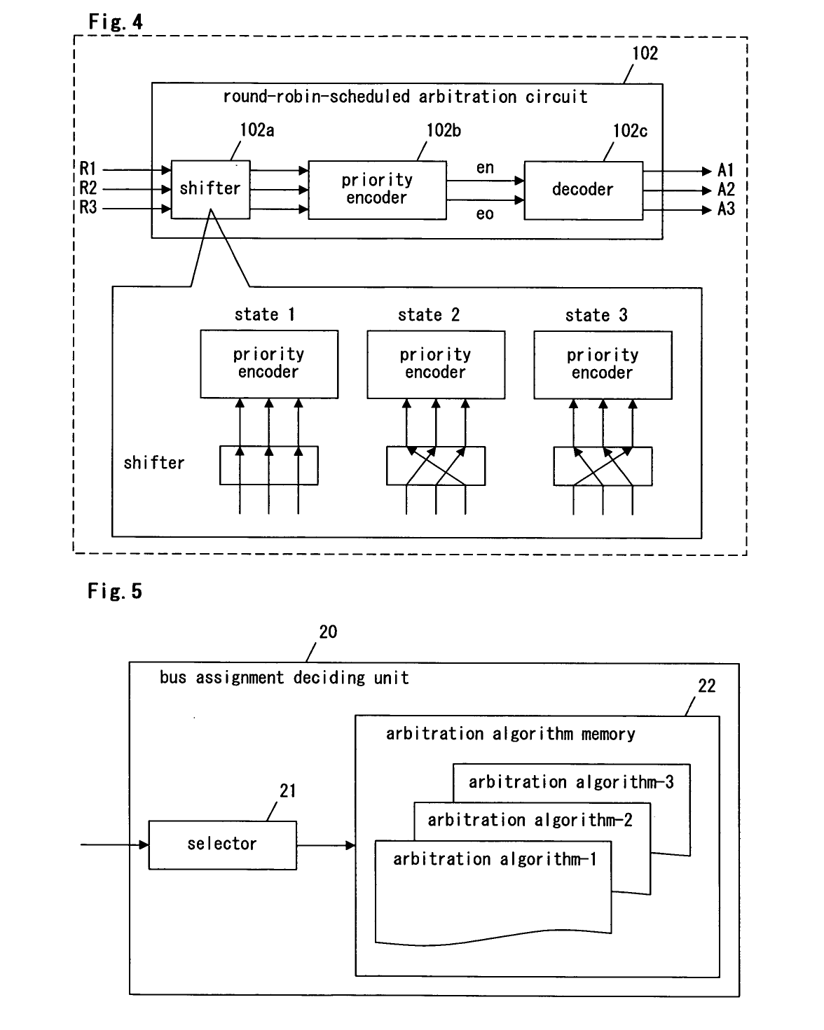

FIG. 4 is a block diagram illustrating a round-robin-scheduled arbitration circuit in Embodiment 1 of the present invention.

The round-robin-scheduled arbitration circuit 102 of the present embodiment includes a shifter 102a, a priority encoder 102b, and a decoder 102c, and inputs the bus requests R1, R2, and R3, and outputs the bus replies A1, A2, and A3 after the bus arbitration.

As shown in the enlargement of FIG. 4, the shifter 102a switches the input “R3R2R1” in 3 bits to a state 1, a state 2, and a state 3 cyclically, and outputs the input to the priority encoder 102b in the latter stage. The priority encoder 102b and the decoder 102c perform the completely same operation as the priority encoder 103a and decoder 103b of the fixed-priority-scheduled arbitration circuit 103 shown in FIG. 3. Consequently, the decoder 102c outputs the decoder output “A3A2A1” in 3 bits.

In this way, a high-speed bus-arbitration processing is realizable by the round-robin-scheduled arbitration circuit 102 shown in FIG. 4.

It is also possible to alternatively realize the bus arbitration described above by software.

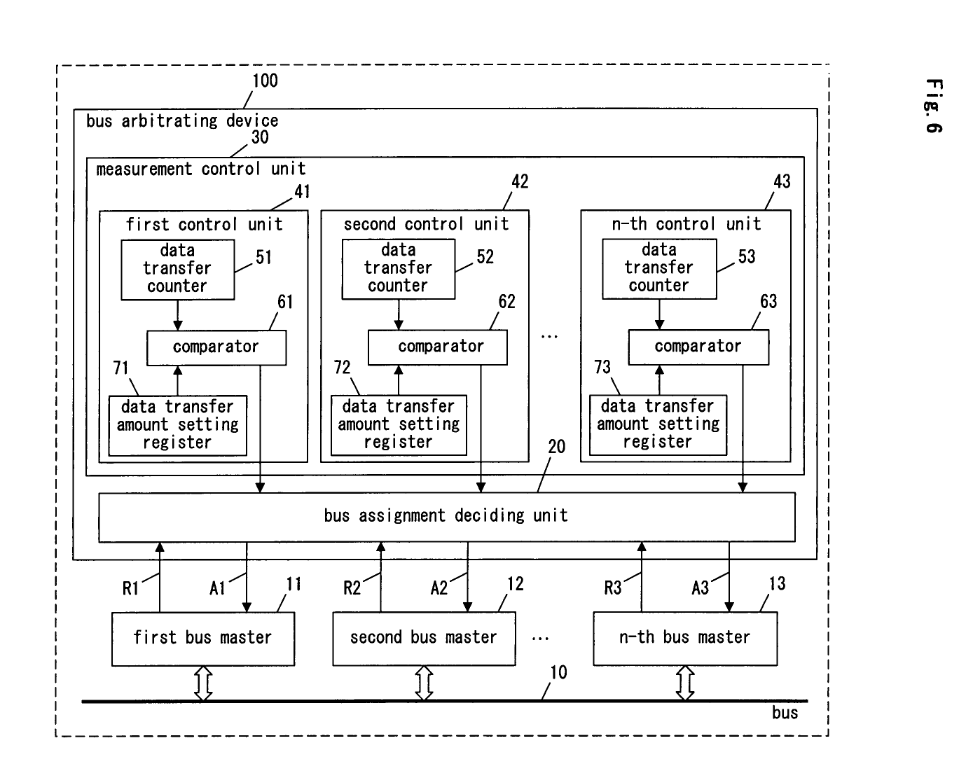

FIG. 5 is a block diagram illustrating a bus assignment deciding unit 20 in Embodiment 1 of the present invention. The bus assignment deciding unit 20 of the present embodiment includes an arbitration algorithm memory 22 which stores a plurality of bus-arbitration-algorithm programs, and a selector 21 which chooses one of the plurality of bus-arbitration-algorithm programs.

When the control information, indicating that the system operating time has passed the time period, is notified by the comparator 32 of FIG. 1, the selector 21 chooses a new bus-arbitration-algorithm program from the arbitration algorithm memory 22, based on the control information, and the bus assignment deciding unit 20 executes the program. In this way, the bus assignment deciding unit 20 from then on performs arbitration of the bus 10, according to the new selected bus arbitration algorithm.

In the bus assignment deciding unit 20 of the present embodiment, the plurality of bus-arbitration-algorithm programs are stored in the arbitration algorithm memory 22 which is an internal memory possessed by the bus assignment deciding unit 20. However, these programs may be alternatively supplied from a memory provided in the exterior of the bus arbitrating device 100.

The bus-arbitration-algorithm program which is executed by the bus assignment deciding unit 20 of the present embodiment may be a fixed-priority scheduling, or alternatively, may be a round-robin scheduling.

As explained above, the bus arbitrating device 100 of the present embodiment alters the bus arbitration algorithm for determining the priority with which each bus master uses the bus 10, every time when the system operating time passes the time period set up in advance.

By performing like this, it is possible to avoid a trend that the right of use of the bus 10 is allowed only to a certain specific bus master depending on one bus arbitration algorithm. Consequently, it is possible to execute processing of each bus master in a balanced manner in the entire system.

### Embodiment 2

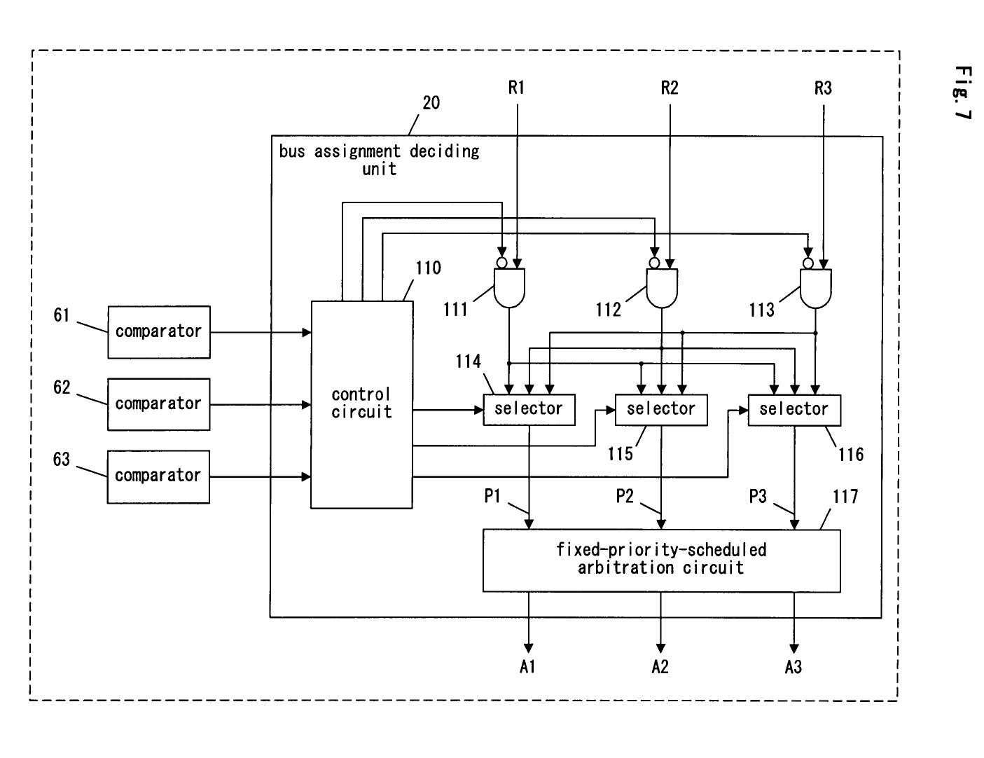

FIG. 6 is a block diagram illustrating a bus arbitrating device, and a layout drawing illustrating a bus arbitrating device and a plurality of bus masters, in Embodiment 2 of the present invention. In FIG. 6, the same components as those in FIG. 1 are attached with the same reference symbols or numerals and the descriptions thereof are omitted.

The bus arbitrating device 100 according to the present embodiment comprises a bus assignment deciding unit 20 and a measurement control unit 30. The measurement control unit 30 includes a first control unit 41 corresponding to the first bus master 11, a second control unit 42 corresponding to the second bus master 12, and an n-th control unit 43 corresponding to the n-th bus master 13.

The first control unit 41 includes a data transfer counter 51, a comparator 61, and a data transfer amount setting register 71; the second control unit 42 includes a data transfer counter 52, a comparator 62, and a data transfer amount setting register 72; and the n-th control unit 43 includes a data transfer counter 53, a comparator 63, and a data transfer amount setting register 73.

Each of the data transfer counters 51-53 corresponds to the data transfer amount measuring unit, and each of the data transfer amount setting registers 71-73 corresponds to the data transfer amount setting unit.

Operation of the bus arbitrating device 100 of the present embodiment is first explained in the following, in the relation between the first bus master 11 and the first control unit 41.

The first bus master 11 makes a request for use of the bus 10 by a bus request R1 to the bus arbitrating device 100. When the bus request R1 from the first bus master 11 is received, the bus arbitrating device 100 determines the priority with which the first bus master 11 uses the bus 10, according to the bus arbitration algorithm currently executed, and issues the use permission of the bus 10 to the first bus master 11 by a bus reply A1.

On the other hand, in the first control unit 41, the data transfer counter 51 measures the accumulated data transfer amount which is the accumulation of the amount of data transferred by the first bus master 11 via the bus 10. The comparator 61 compares the accumulated data transfer amount measured by the data transfer counter 51, with the reference data transfer amount set in the data transfer amount setting register 71 in advance for the first bus master 11. Every time when the accumulated data transfer amount reaches the reference data transfer amount, the comparator 61 generates the control information indicating that the predetermined amount of data has been transferred to the first bus master 11, and notifies the bus assignment deciding unit 20 of the generated control information.

Operation in the second control unit 42 and the n-th control unit 43 is the same as the operation in the first control unit 41.

In the second control unit 42, the data transfer counter 52 measures the accumulated data transfer amount of the second bus master 12. The comparator 62 compares the accumulated data transfer amount measured by the data transfer counter 52, with the reference data transfer amount set in the data transfer amount setting register 72 in advance for the second bus master 12. Every time when the accumulated data transfer amount reaches the reference data transfer amount, the comparator 62 generates the control information indicating that the predetermined amount of data has been transferred to the second bus master 12, and notifies the bus assignment deciding unit 20 of the generated control information.

In the n-th control unit 43, the data transfer counter 53 measures the accumulated data transfer amount of the n-th bus master 13. The comparator 63 compares the accumulated data transfer amount measured by the data transfer counter 53, with the reference data transfer amount set in the data transfer amount setting register 73 in advance for the n-th bus master 13. Every time when the accumulated data transfer amount reaches the reference data transfer amount, the comparator 63 generates the control information indicating that the predetermined amount of data has been transferred to the third bus master 13, and notifies the bus assignment deciding unit 20 of the generated control information.

When the notice of the control information from any one of the comparators 61-63 is received, the bus assignment deciding unit 20 changes the bus arbitration algorithm currently executed to a new bus arbitration algorithm to be executed. From then on, the bus assignment deciding unit 20, upon receiving the bus-use request from each bus master, determines the priority with which each bus master uses the bus 10, according to the new bus arbitration algorithm, and the bus assignment deciding unit 20 issues the use permission of the bus 10 to each bus master. At the same time, the bus assignment deciding unit 20 resets the values of the data transfer counters 51-53, so that the data transfer counters 51-53 are able to measure a respectively new accumulated data transfer amount.

The concrete embodiment for the change of the bus arbitration algorithm in the present embodiment is mentioned later.

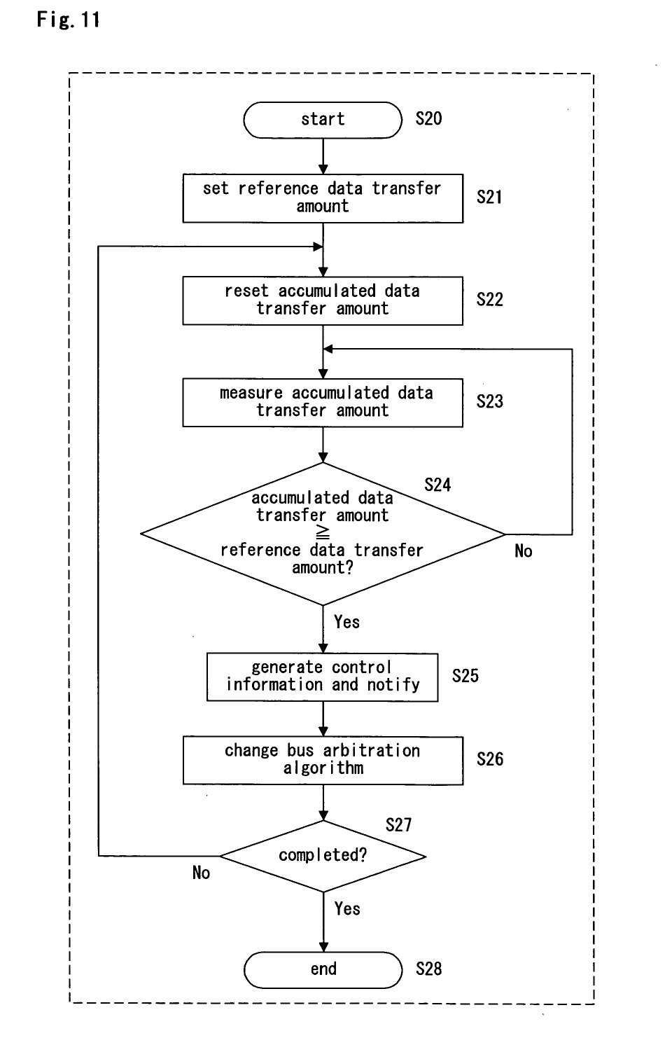

The flow of operation in the bus arbitrating device 100 in the present embodiment is explained according to FIG. 11, with concurrent reference to FIG. 6.

FIG. 11 is a flow chart for bus-arbitration-algorithm change in Embodiment 2 of the present invention.

Processing starts at Step S20.

In Step S21, the reference data transfer amount corresponding to each of the bus masters is set up for each of the data transfer amount setting registers 71-73 in the bus arbitrating device 100. The reference data transfer amount set in each of the data transfer amount setting registers 71-73 may differ depending on the corresponding bus master.

In Step S22, the data transfer counters 51-53 are reset, and in Step S23, each of the data transfer counters 51-53 measures the accumulated data transfer amount of the corresponding each of the bus masters.

In Step S24, each of the comparators 61-63 compares the accumulated data transfer amount of the corresponding each of the bus masters measured by each of the data transfer counters 51-53 in Step S23, with each reference data transfer amount set in each of the data transfer amount setting registers 71-73 in Step S21. If the accumulated data transfer amount is less than the reference data transfer amount in any of the comparators 61-63, and the comparison result is “No”, the control returns to Step S23 and the transfer time counters 81-83 continue to measure the respective accumulated data transfer amounts. When the accumulated data transfer amount reaches the reference data transfer amount in any one of the comparators 61-63, and the comparison result is “Yes”, the control moves to Step S25.

In Step S25, the comparator which has turned the comparison result to “Yes” in Step S24 generates the control information indicating that the accumulated data transfer amount in the corresponding bus master has reached the reference data transfer amount, and notifies the bus assignment deciding unit 20 of the generated control information.

In Step S26, the bus assignment deciding unit 20 changes the bus arbitration algorithm currently executed to a new bus arbitration algorithm based on the notified control information, and executes the new bus arbitration algorithm. At this time, the bus assignment deciding unit 20 can execute the new bus arbitration algorithm which forbids the bus use, or raises or conversely lowers the priority of the bus use, for the bus master for which the accumulated data transfer amount has reached the reference data transfer amount.

In Step S27, it is judged whether a series of processing has completed. If the series of processing has not completed, the judgment result is “No”, and the control returns to Step S22, then processing from Step S22 to the step S27 are repeated. If the series of processing has completed, the judgment result is “Yes”, and the control moves to Step S28 to end the processing.

In the bus arbitrating device 100 of the present embodiment, a plurality of control units are provided in a one-to-one correspondence manner, corresponding to a plurality of bus masters, and the accumulated data transfer amount for every bus master is measured. Therefore, the bus arbitration based on the accumulated data transfer amount for every bus master is possible.

For example, when the comparator 61 generates the control information indicating that the predetermined amount of data has been transferred for the first bus master 11, and notifies the bus assignment deciding unit 20 of the generated control information, the bus assignment deciding unit 20 can change the bus arbitration algorithm to a bus arbitration algorithm which lowers the priority in the bus use by the first bus master 11.

Consequently, after the change of the bus arbitration algorithm, it becomes possible to lower the priority in the bus use by the first bus master 11 which uses the bus more often, thereby allowing balanced bus use in the whole system.

Alternatively, when the comparator 61 generates the control information indicating that the predetermined amount of data has been transferred for the first bus master 11, and notifies the bus assignment deciding unit 20 of the generated control information, the bus assignment deciding unit 20 can change the bus arbitration algorithm into a bus arbitration algorithm which raises the priority in the bus use by the first bus master 11.

Consequently, for the first bus master 11 which treats much data transfer amount, allocation of the right of bus use is increased, thereby further advancing the processing of the first bus master 11.

The bus-arbitration-algorithm program which is executed by the bus assignment deciding unit 20 of the present embodiment should be preferably one that follows an adaptive system as mentioned above. However, the bus-arbitration-algorithm program may be a fixed-priority scheduling, or alternatively, may be a round-robin scheduling. As the result, the system configuration will be simplified.

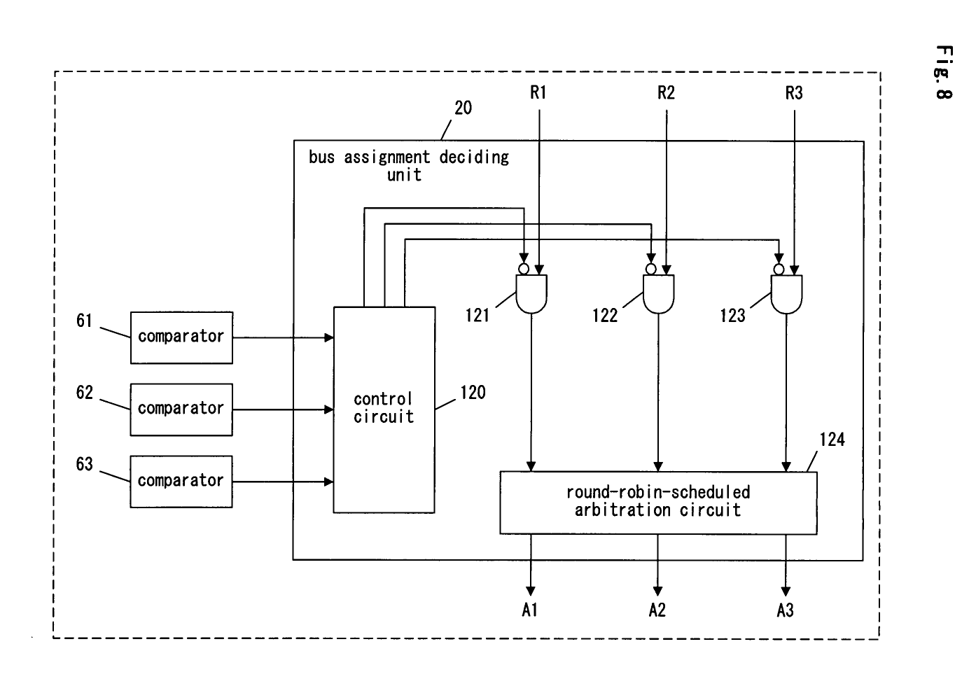

FIG. 7 is a block diagram illustrating a bus assignment deciding unit 20 in Embodiment 2 of the present invention. The bus assignment deciding unit 20 of the present embodiment performs bus arbitration according to a fixed-priority scheduling. Namely, the bus assignment deciding unit 20 includes a control circuit 110, AND circuits 111, 112, and 113, selectors 114, 115, and 116, and a fixed-priority-scheduled arbitration circuit 117. The comparison results from comparators 61, 62, and 63 shown in FIG. 6 are inputted into the control circuit 110. The control circuit 110 controls the AND circuits 111, 112, and 113 and the selectors 114, 115, and 116, according to the input.

The AND circuits 111, 112, and 113 are provided for blocking out the bus requests R1, R2, and R3.

The selectors 114, 115, and 116 are provided for changing the priority of the bus requests R1, R2, and R3. In the fixed-priority-scheduled arbitration circuit 117 of the present embodiment, it is assumed that the priority of an input P1 is set highest, then the priority of an input P2 is set next-highest, and the priority of an input P3 is set lowest. For example, when the bus request R1 is chosen by the selector 115 and fed as the input P2, the bus request R2 is chosen by the selector 114 and fed as the input P1, and the bus request R3 is chosen by the selector 116 and fed as the input P3; then, the priority for the bus request R2 becomes highest, the priority for the bus request R2 becomes next-highest, and the priority for the bus request R3 becomes lowest.

The fixed-priority-scheduled arbitration circuit 103 of FIG. 3 used in Embodiment 1 of the present invention can be used for the fixed-priority-scheduled arbitration circuit 117 of the present embodiment.

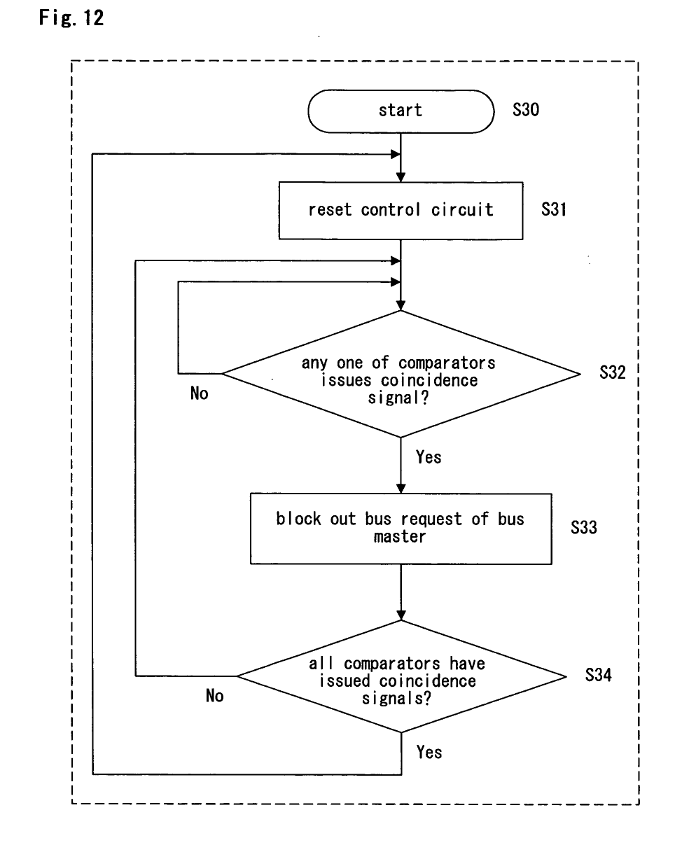

Operation of the bus assignment deciding unit 20 of the present embodiment is explained in the following according to FIGS. 12-14, with concurrent reference to FIG. 7.

FIG. 12 is a flow chart for the bus assignment deciding unit 20 in Embodiment 2 of the present invention.

FIG. 12 explains a case where the fixed-priority scheduling is chosen as the bus arbitration algorithm and the bus use is forbidden for a bus master in which the accumulated data transfer amount has reached the reference data transfer amount.

Processing starts in Step S30.

In Step S31, the control circuit 110 is reset.

In Step S32, the control waits for any one of the comparators 61, 62, and 63 to issue a coincidence signal. As an example, it is assumed that the accumulated data transfer amount has reached the reference data transfer amount in the first bus master 11 shown in FIG. 6, and that the corresponding comparator 61 detects the fact and issues a coincidence signal to the control circuit 110 of the bus assignment deciding unit 20.

In Step S33, the AND circuit 111 corresponding to the comparator 61 which has issued the coincidence signal blocks out the bus request R1, and from then on, the bus request R1 from the first bus master 11 is not inputted into the selectors 114-116. Then, the selectors 114-116 choose the bus request R2 and the bus request R3. Therefore, for the bus request R2 and the bus request R3, the bus arbitration is executed with a higher priority in the fixed-priority-scheduled arbitration circuit 117.

In Step S34, it is judged whether all comparators have issued the coincidence signal. If there is still a comparator which has not issued the coincidence signal, and the judgment result is “No”, then the control returns to Step S32, and from Step S32 to Step S34 are repeated. If all the comparators have issued the coincidence signals, and the judgment result is “Yes”, then the control returns to Step S31, and the processing from Step S31 to Step S34 is repeated.

In this way, according to the flow chart of the present embodiment, the bus use of a bus master to which the accumulated data transfer amount has reached the reference data transfer amount can be forbidden; thereby, the priority of the bus use of the other bus masters to which the accumulated data transfer amount has not reached the reference data transfer amount can be raised.

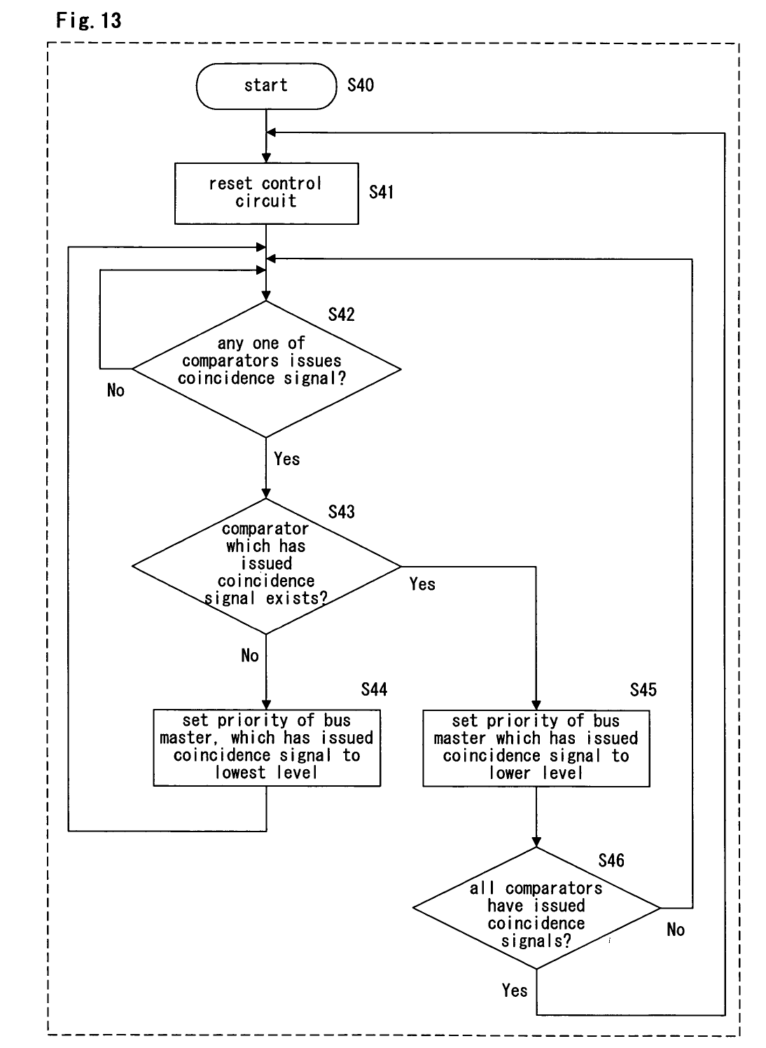

FIG. 13 is a flow chart for a bus assignment deciding unit 20 in Embodiment 2 of the present invention.

FIG. 13 explains a case where the fixed-priority scheduling is chosen as the bus arbitration algorithm and the priority of bus use is lowered for a bus master to which the accumulated data transfer amount has reached the reference data transfer amount.

Processing starts in Step S40.

In Step S41, the control circuit 110 is reset.

In Step S42, the control waits for any one of the comparators 61, 62, and 63 to issue a coincidence signal. As an example, it is assumed that the accumulated data transfer amount has reached the reference data transfer amount in the first bus master 11 shown in FIG. 6, and that the corresponding comparator 61 detects the fact and issues a coincidence signal to the control circuit 110 of the bus assignment deciding unit 20.

In Step S43, it is judged whether there is any comparator which has already issued the coincidence signal. In the present example, there is no comparator which has already issued the coincidence signal, and the judgment result is “No”; therefore, the control moves to Step S44.

In Step S44, the priority of the first bus master 11 corresponding to the comparator 61 which has issued the coincidence signal is set lowest. Namely, the bus request R1 is chosen by the selector 116, and fed to the fixed-priority-scheduled arbitration circuit 117, as the input P3 with the lowest priority. Consequently, the bus request R2 and the bus request R3 are chosen by the selector 114 or the selector 115, and are fed into the fixed-priority-scheduled arbitration circuit 117, as the input P1 with the highest priority or as the input P2 with the next-highest priority. Therefore, the bus request R2 and the bus request R3 are treated with a higher priority from then on.

After these pieces of processing are completed, the control returns to Step S42.

In Step S42, the control waits for either of the comparator 62 or the comparator 63 to issue a coincidence signal. As an example, it is assumed that the comparator 62 has issued the coincidence signal.

In Step S43, it is judged whether there is any comparator which has already issued the coincidence signal. In the present example, the comparator 61 has already issued the coincidence signal, therefore, the judgment result is “Yes” and the control moves to Step S45.

In Step S45, the priority of the second bus master 12 corresponding to the comparator 62 which has issued the coincidence signal is set at a lower level. Namely, the bus request R2 is chosen by the selector 115 and fed to the fixed-priority-scheduled arbitration circuit 117, as the input P2 with the second lowest priority. Therefore, the bus request R3 will be treated with the highest priority from then on.

In Step S46, it is judged whether all comparators have issued the coincidence signal. If all comparators have not yet issued the coincidence signal, and the judgment result is “No”; then the control returns to Step S42, and the processing from Step S42 to Step S46 is repeated. If all comparators have issued the coincidence signal, and the judgment result is “Yes”, the control returns to Step S41 to reset the control circuit 110 again, and then the processing from Step S41 is repeated. In this way, according to the flow chart of the present embodiment, the priority of the bus use of a bus master for which the accumulated data transfer amount has reached the reference data transfer amount can be lowered; thereby, the priority of the bus use of the other bus masters for which the accumulated data transfer amount does not reach the reference data transfer amount can be effectively raised.

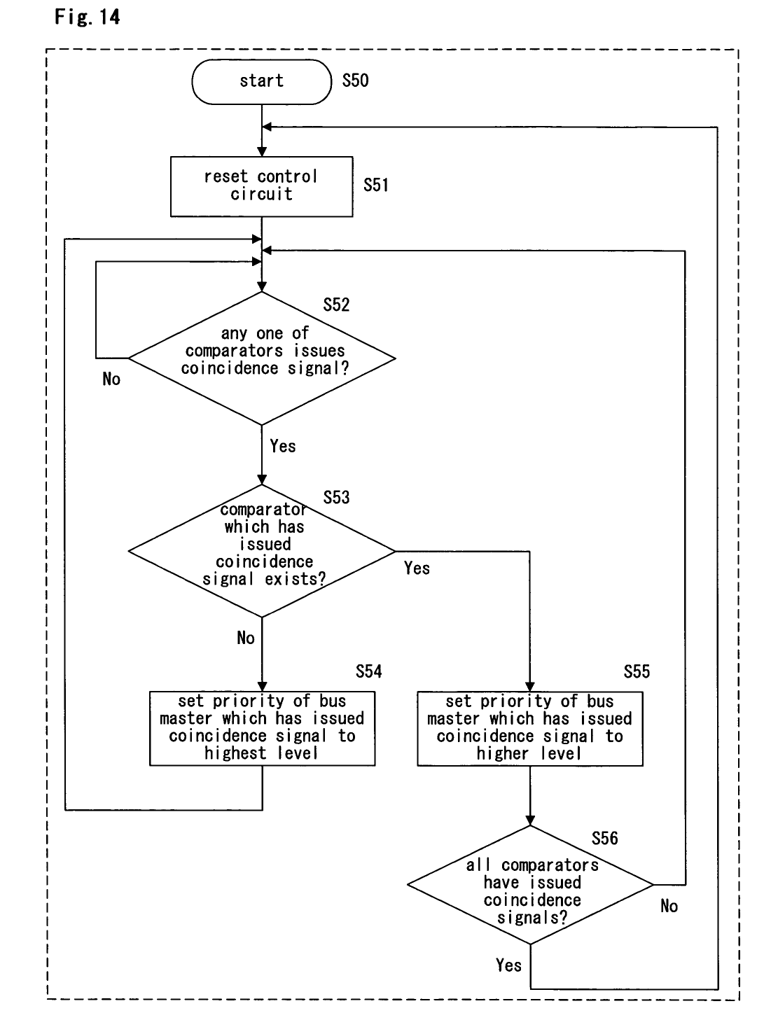

FIG. 14 is a flow chart for a bus assignment deciding unit 20 in Embodiment 2 of the present invention.

FIG. 14 explains a case where the fixed-priority scheduling is chosen as the bus arbitration algorithm and the priority of bus use is raised for a bus master to which the accumulated data transfer amount has reached the reference data transfer amount.

Processing starts in Step S50.

In Step S51, the control circuit 110 is reset.

In Step S52, the control waits for any one of the comparators 61, 62, and 63 to issue a coincidence signal. As an example, it is assumed that the accumulated data transfer amount has reached the reference data transfer amount in the first bus master 11 shown in FIG. 6, and that the corresponding comparator 61 detects the fact and issues a coincidence signal to the control circuit 110 of the bus assignment deciding unit 20.

In Step S53, it is judged whether there is any comparator which has already issued the coincidence signal. In the present example, there is no comparator which has already issued the coincidence signal, and the judgment result is “No”; therefore, the control moves to Step S54.

In Step S54, the priority of the first bus master 11 corresponding to the comparator 61 which has issued the coincidence signal is set highest. Namely, the bus request R1 is chosen by the selector 114, and fed to the fixed-priority-scheduled arbitration circuit 117, as the input P1 with the highest priority. Consequently, the bus request R1 will be treated with the highest priority. After these pieces of processing are completed, the control returns to Step S52.

In Step S52, the control waits for either of the comparator 62 or the comparator 63 to issue a coincidence signal. As an example, it is assumed that the comparator 62 has issued the coincidence signal.

In Step S53, it is judged whether there is any comparator which has already issued the coincidence signal. In the present example, the comparator 61 has already issued the coincidence signal, therefore, the judgment result is “Yes” and the control moves to Step S55.

In Step S55, the priority of the second bus master 12 corresponding to the comparator 62 which has issued the coincidence signal is set at a higher level. Namely, the bus request R2 is chosen by the selector 115 and fed to the fixed-priority-scheduled arbitration circuit 117, as the input P2 with the second highest priority. Therefore, the bus request R3 will be treated with the lowest priority from then on.

In Step S56, it is judged whether all comparators have issued the coincidence signal. If all comparators have not yet issued the coincidence signal, and the judgment result is “No”; the control returns to Step S52, and the processing from Step S52 to Step S56 is repeated. If all comparators have issued the coincidence signal, and the judgment result is “Yes”; the control returns to Step S51 to reset the control circuit 110 again, and then the processing from Step S51 is repeated.

In this way, it becomes possible to increase allocation of the right of bus use to a bus master possessing much data transfer amount, thereby further advancing the processing of a bus master which needs much data transfer.

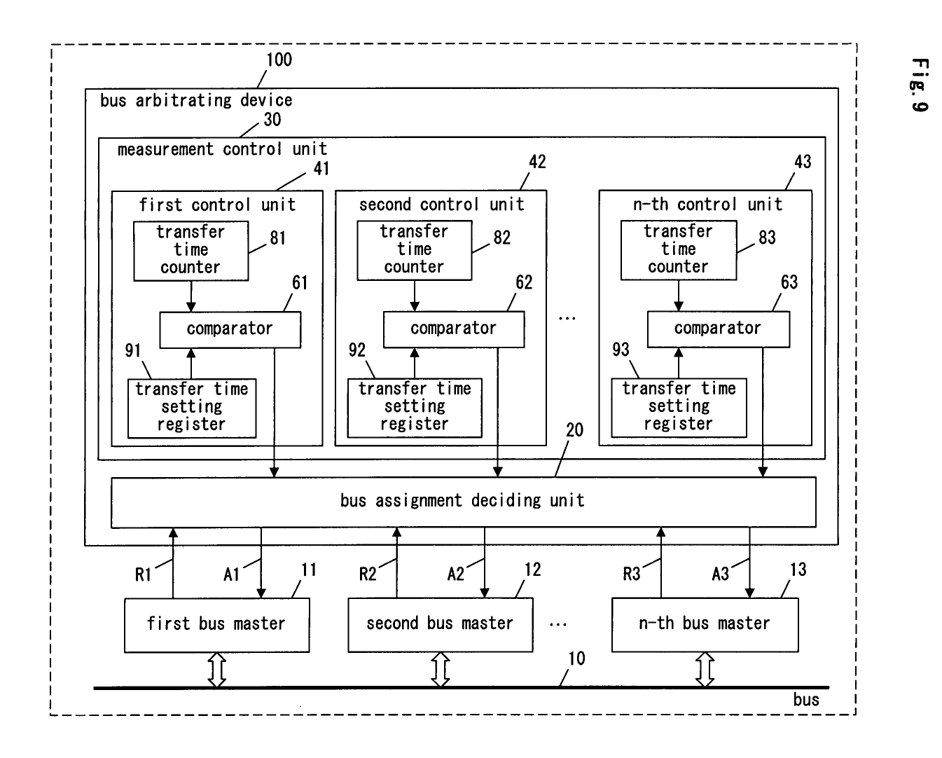

FIG. 8 is a block diagram illustrating a bus assignment deciding unit 20 in Embodiment 2 of the present invention. The bus assignment deciding unit 20 of the present embodiment performs bus arbitration with a round-robin scheduling. Namely, the bus assignment deciding unit 20 includes a control circuit 120, AND circuits 121, 122, and 123, and a round-robin-scheduled arbitration circuit 124. The comparison results from comparators 61, 62, and 63 shown in FIG. 6 are inputted into the control circuit 120. The control circuit 120 controls the AND circuits 121, 122, and 123, according to the input. The AND circuits 121, 122, and 123 are provided for blocking out the bus requests R1, R2, and R3.

In FIG. 8, when the coincidence signal has not been issued from any one of the comparators 61, 62, and 63, the round-robin-scheduled arbitration circuit 124 chooses cyclically the bus requests R1, R2, and R3 and issues the bus replies A1, A2, and A3.

The round-robin-scheduled arbitration circuit 102 of FIG. 4 used in Embodiment 1 of the present invention can be used for the round-robin-scheduled arbitration circuit 124 of the present embodiment.

As an example, it is assumed that the accumulated data transfer amount has reached the reference data transfer amount in the first bus master 11 shown in FIG. 6, and that the corresponding comparator 61 detects the fact and issues a coincidence signal to the control circuit 110 of the bus assignment deciding unit 20. Then, the control circuit 120 controls the AND circuit 121, and blocks out the bus request R1 corresponding to the first bus master 11 for which the coincidence signal has been issued. From then on, the bus requests which are inputted into the round-robin-scheduled arbitration circuit 124 are the bus request R2 and the bus request R3. The round-robin-scheduled arbitration circuit 124 chooses cyclically these two bus requests and issues the bus replies A2 and A3. Therefore, the priority of the bus request R2 and the bus request R3 becomes higher substantially.

In this way, the bus assignment deciding unit 20 in Embodiment 2 of the present invention shown in FIG. 8 performs bus arbitration by blocking out the bus request of the bus master which has issued the coincidence signal, and choosing cyclically the bus requests of the other bus masters. By this scheme, it is possible to raise the priority in the bus use of bus masters for which the accumulated data transfer amount has not reached the reference data transfer amount.

In the bus arbitrating device 100 of the present embodiment, the measurement control unit 30 includes a plurality of control units which correspond to a plurality of bus masters in a one-to-one correspondence manner, and measures the accumulated data transfer amount for every bus master. However, the measurement control unit 30 may alternatively provide a single control unit, and measure the accumulated data transfer amount of each bus master separately by time sharing. With this alternative, the same effect as the bus arbitrating device 100 of the present embodiment can be acquired.

### Embodiment 3

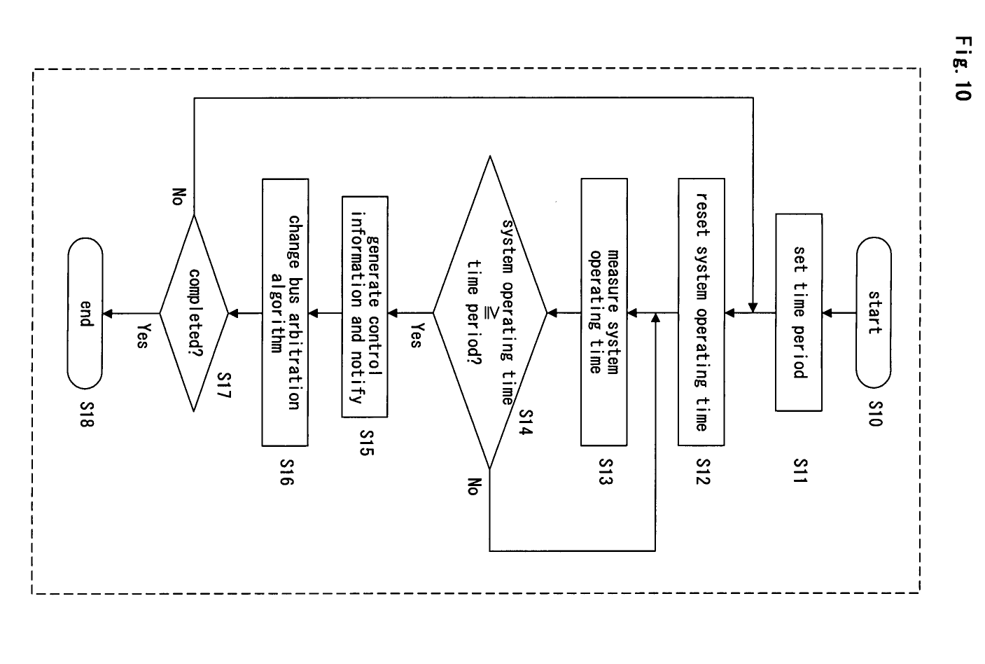

FIG. 9 is a block diagram illustrating a bus arbitrating device in Embodiment 3 of the present invention, and a layout drawing illustrating a bus arbitrating device and a plurality of bus masters. In FIG. 9, the same components as those in FIG. 1 are attached with the same reference symbols or numerals and the descriptions thereof are omitted.

A bus arbitrating device 100 according to the present embodiment comprises a bus assignment deciding unit 20 and a measurement control unit 30. The measurement control unit 30 includes a first control unit 41 corresponding to the first bus master 11, a second control unit 42 corresponding to the second bus master 12, and an n-th control unit 43 corresponding to the n-th bus master 13.

The first control unit 41 includes a transfer time counter 81, a comparator 61, and a transfer time setting register 91; the second control unit 42 includes a transfer time counter 82, a comparator 62, and a transfer time setting register 92; and the n-th control unit 43 includes a transfer time counter 83, a comparator 63, and a transfer time setting register 93.

Each of the transfer time counters 81-83 corresponds to the data transfer time measuring unit, and each of the transfer time setting registers 91-93 corresponds to the data transfer time setting unit.

Operation of the bus arbitrating device 100 of the present embodiment is first explained in the following, in the relation between the first bus master 11 and the first control unit 41.

The first bus master 11 makes a request for use of the bus 10 by a bus request R1 to the bus arbitrating device 100. When the bus-use request from the first bus master 11 is received, the bus arbitrating device 100 determines the priority with which the first bus master 11 uses the bus 10, according to the bus arbitration algorithm currently executed, and the bus arbitrating device 100 issues the use permission of the bus 10 to the first bus master 11 by a bus reply A1.

On the other hand, in the first control unit 41, the transfer time counter 81 measures the necessary data transfer time which is the time consumed for the data transfer performed by the first bus master 11 via the bus 10. The comparator 61 compares the necessary data transfer time measured by the transfer time counter 81, with the reference data transfer time set in the transfer time setting register 91 in advance for the first bus master 11. Every time when the necessary data transfer time reaches the reference data transfer time, the comparator 61 generates the control information indicating that the predetermined data transfer time has been consumed for the first bus master 11, and notifies the bus assignment deciding unit 20 of the generated control information.

Operation of the second control unit 42 and the n-th control unit 43 is the same as that of the first control unit 41.

In the second control unit 42, the transfer time counter 82 measures the necessary data transfer time which is the time consumed for the data transfer performed by the second bus master 12 via a bus 10. The comparator 62 compares the necessary data transfer time measured by the transfer time counter 82, with the reference data transfer time set in the transfer time setting register 92 in advance for the second bus master 12. Every time when the necessary data transfer time reaches the reference data transfer time, the comparator 62 generates the control information indicating that the predetermined data transfer time has been consumed for the second bus master 12, and notifies the bus assignment deciding unit 20 of the generated control information.

In the n-th control unit 43, the transfer time counter 83 measures the necessary data transfer time which is the time consumed for the data transfer performed by the n-th bus master 13 via a bus 10. The comparator 63 compares the necessary data transfer time measured by the transfer time counter 83, with the reference data transfer time set in the transfer time setting register 93 in advance for the n-th bus master 13. Every time when the necessary data transfer time reaches the reference data transfer time, the comparator 63 generates the control information indicating that the predetermined data transfer time has been consumed for the n-th bus master 13, and notifies the bus assignment deciding unit 20 of the generated control information.

When the notice of the control information from any one of the comparators 61-63 is received, the bus assignment deciding unit 20 changes the bus arbitration algorithm currently executed to a new bus arbitration algorithm, based on the notified control information, and executes the new bus arbitration algorithm. From then on, the bus assignment deciding unit 20, upon receiving the bus-use request from each bus master, determines the priority with which each bus master uses the bus 10, according to the new bus arbitration algorithm. The bus assignment deciding unit 20 issues the use permission of the bus 10 to each bus master. At the same time, the bus assignment deciding unit 20 resets the values of the transfer time counters 81-83, so that the transfer time counters 81-83 are able to measure respectively a new necessary data transfer time.

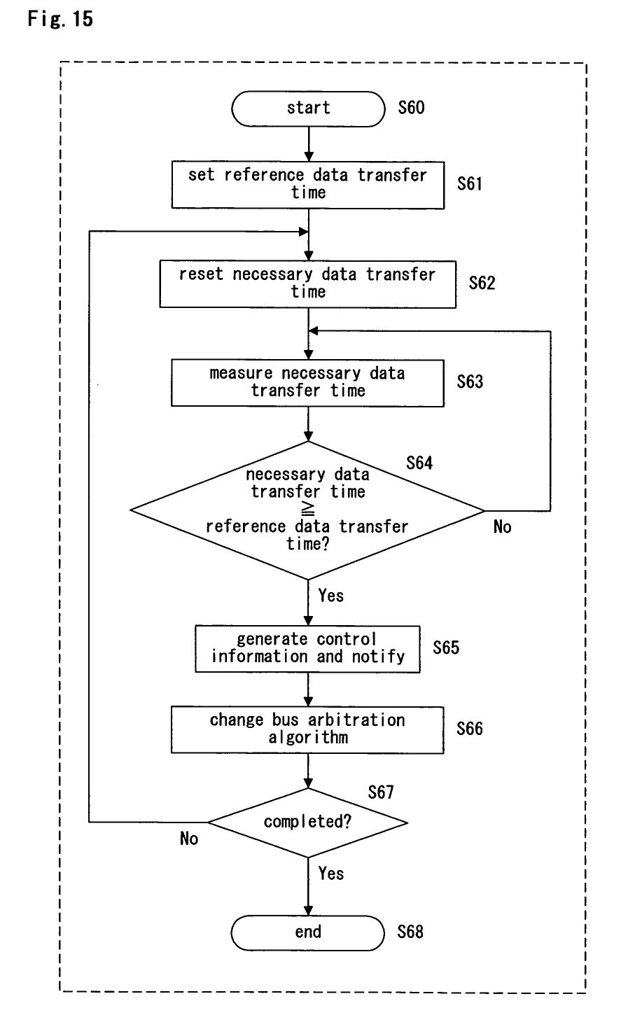

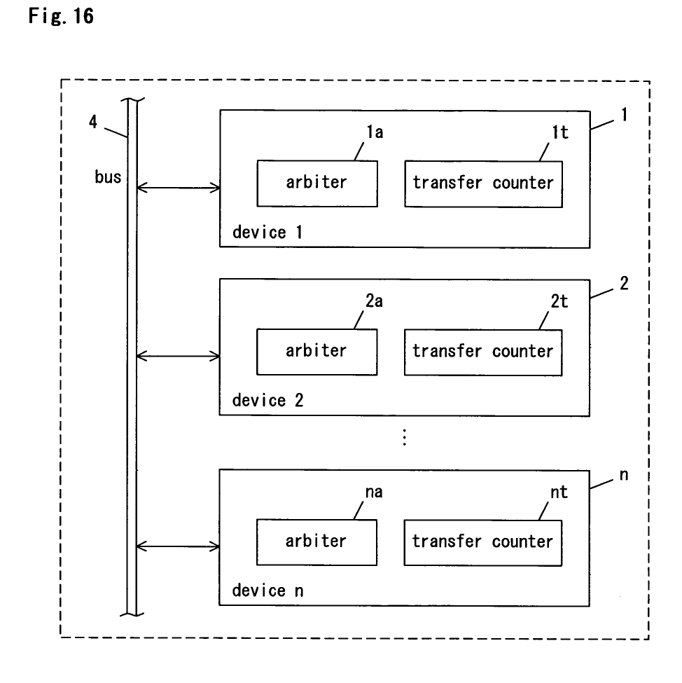

The flow of operation in the bus arbitrating device 100 in the present embodiment is explained according to FIG. 15, with concurrent reference to FIG. 9.

FIG. 15 is a flow chart for bus-arbitration-algorithm change in Embodiment 3 of the present invention.

Processing starts at Step S60 in the bus arbitrating device 100.

In Step S61, the reference data transfer time corresponding to each bus master is set in each of the transfer time setting registers 91-93.

In Step S62, the transfer time counters 81-83 are reset.

In Step S63, the transfer time counters 81-83 measure the necessary data transfer time of each bus master.

In Step S64, each of the comparators 61-63 compares the necessary data transfer time for each bus master measured by each of the transfer time counters 81-83 in Step S63, with the corresponding reference data transfer time set in each of the transfer time setting registers 91-93 in Step S61.

If the necessary data transfer time is less than the corresponding reference data transfer time in any of the comparators 61-63, and the comparison result is “No”, the control returns to Step S63, and the transfer time counters 81-83 continue to measure respectively the necessary data transfer time. When the necessary data transfer time reaches the reference data transfer time in any one of the comparators 61-63, and the comparison result is “Yes”, the control moves to Step S65.

In Step S65, the comparator which determined the comparison result as “Yes” in Step S64 generates the control information indicating that the necessary data transfer time in the corresponding bus master has reached the reference data transfer time, and notifies the bus assignment deciding unit 20 of the generated control information.

In Step S66, the bus assignment deciding unit 20 changes the bus arbitration algorithm currently executed to a new bus arbitration algorithm, based on the notified control information, and executes the new bus arbitration algorithm. At this time, the bus assignment deciding unit 20 can also execute a special new bus arbitration algorithm which raises or conversely lowers the priority of the bus use of a bus master for which the necessary data transfer time has reached the reference data transfer time.

In Step S67, it is judged whether a series of processing has been completed. If the series of processing is not completed, and the judgment result is “No”, the control returns to Step S62, and the processing from Step S62 to Step S67 is repeated. If the series of processing is completed, and the judgment result is “Yes”, the control moves to Step S68 to end the series of processing.

The bus arbitrating device 100 of the present embodiment provides a plurality of control units corresponding to a plurality of bus masters, and measures the necessary data transfer time for every bus master. Therefore, the bus arbitration based on the necessary data transfer time per every bus master is possible.

For example, when the comparator 61 notifies the bus assignment deciding unit 20 of the fact that the predetermined reference data transfer time is consumed in the first bus master 11, the bus assignment deciding unit 20 can change the bus arbitration algorithm into a bus arbitration algorithm which lowers the priority in the bus use by the first bus master 11. Consequently, after the change of the bus arbitration algorithm, it becomes possible to lower the priority in the bus use by the first bus master 11 which uses the bus more often, thereby allowing balanced bus use by the whole system.

Or conversely, when the comparator 61 notifies the bus assignment deciding unit 20 of the fact that the predetermined reference data transfer time has been consumed in the first bus master 11, the bus assignment deciding unit 20 can change the bus arbitration algorithm into a bus arbitration algorithm which raises the priority in the bus use by the first bus master 11. With this scheme, it becomes possible to increase allocation of the right of bus use to the first bus master 11 which possesses much data transfer amount, thereby further advancing the processing of the first bus master 11.

The bus-arbitration-algorithm program which is executed by the bus assignment deciding unit 20 of the present embodiment should be preferably one that follows an adaptive system as mentioned above. However, the bus-arbitration-algorithm program may be a fixed-priority scheduling, or alternatively, may be a round-robin scheduling. As the result, the system configuration will be simplified.

In the detailed embodiment of the change of the bus arbitration algorithm according to the present embodiment, it is possible to employ the bus assignment deciding unit shown in FIG. 7 and the bus assignment deciding unit shown in FIG. 8, in a similar manner as explained in Embodiment 2 of the present invention. In this case, the term “accumulated data transfer amount” should read as the term “necessary data transfer time”, and the term “reference data transfer amount” should read as the term “reference data transfer time.” Accordingly, in the explanation of Embodiment 2 of the present invention, the sentence “the comparators 61, 62, and 63 issue a coincidence signal, when the accumulated data transfer amount has reached the reference data transfer amount in the corresponding bus master” should read as the sentence “the comparators 61, 62, and 63 issue a coincidence signal, when the necessary data transfer time has reached the reference data transfer time in the corresponding bus master.”

When the bus assignment deciding unit 20 shown in FIG. 7 is employed in the present embodiment, it is possible to control the bus use of the bus master for which the necessary data transfer time has reached the reference data transfer time and for which the coincidence signal is issued. The control is performed by blocking out the bus request from then on, or by lowering or conversely raising the priority, based on the fixed-priority scheduling.

When the bus assignment deciding unit 20 shown in FIG. 8 is employed in the present embodiment, it is possible to control the bus use of the bus master for which the necessary data transfer time has reached the reference data transfer time and for which the coincidence signal is issued. The control is performed by blocking out the bus request from then on, or by controlling the bus request from the other bus masters according to the round-robin scheduling.

In the bus arbitrating device 100 of the present embodiment, the measurement control unit 30 provides a plurality of control units corresponding to a plurality of bus masters, and measures the necessary data transfer time for every bus master. However, the measurement control unit 30 may alternatively provide a single control unit, and measure the necessary data transfer time of each bus master separately by time sharing. With this alternative, the same effect as the bus arbitrating device 100 of the present embodiment can be acquired.

As explained above, the purport of the present invention is, in the system including a plurality of bus masters connected to a bus, to adaptively change the priority of the right of bus use of each bus master, thereby attaining optimization of the bus arbitration to the bus request from each bus master. Therefore, various applications are possible unless it deviates from the purport of the present invention.

According to the present invention, in the system including a plurality of bus masters connected to a bus, it is possible to provide a bus arbitrating device and method which can change adaptively the priority of the right of bus use of each bus master, thereby attaining optimization of the bus arbitration to the bus request from each bus master.

### INDUSTRIAL APPLICABILITY

The bus arbitrating device and bus arbitrating method concerning the present invention can be employed, for example, in a multiprocessor LSI which includes a plurality of bus masters connected to a bus and in the related application field.

1. A bus arbitrating device operable to arbitrate data transfer requests in a system including a bus and a plurality of bus masters which are connected to the bus and issue the data transfer requests, said bus arbitrating device comprising:
a measurement control unit operable to measure bus arbitration judgment amount; and
a bus assignment deciding unit operable to arbitrate data transfer requests among the plurality of bus masters, based on a predetermined bus arbitration algorithm,
wherein said measurement control unit measures, as the bus arbitration judgment amount, at least one of: system operating time of the system; accumulated data transfer amount indicative of each accumulation of data amount transferred by each of the plurality of bus masters; and necessary data transfer time indicative of time consumed in data transfer by each of the plurality of bus masters,
wherein said measurement control unit generates control information when the measured bus arbitration judgment amount satisfies a prescribed condition, thereby notifying said bus assignment deciding unit of the generated control information, and
wherein said bus assignment deciding unit changes the bus arbitration algorithm, based on the notified control information, thereby performing new bus arbitration.

2. The bus arbitrating device as defined in claim 1, wherein said measurement control unit comprises:
a timing unit operable to measure the system operating time as the bus arbitration judgment amount;
a time period setting unit operable to set a time period corresponding to a prescribed time; and
a comparing unit operable to compare the system operating time with the time period,
wherein said comparing unit generates, as the control information, information indicative that the prescribed time has elapsed, every time when the system operating time passes the time period, thereby notifying said bus assignment deciding unit of the generated control information, and
wherein said bus assignment deciding unit changes the bus arbitration algorithm, based on the notified control information, thereby performing new bus arbitration.

3. The bus arbitrating device as defined in claim 2, wherein said bus assignment deciding unit selects, based on the notified control information, one of a plurality of bus arbitration algorithms prepared in advance, thereby performing new bus arbitration using the selected bus arbitration algorithm.

4. The bus arbitrating device as defined in claim 3, wherein the bus arbitration algorithm selected by said bus assignment deciding unit is a fixed-priority scheduling.

5. The bus arbitrating device as defined in claim 3, wherein the bus arbitration algorithm selected by said bus assignment deciding unit is a round-robin scheduling.

6. The bus arbitrating device as defined in claim 1, wherein said measurement control unit comprises:
a plurality of data transfer amount measuring units operable to measure, as the bus arbitration judgment amount, accumulated data transfer amount indicative of each accumulation of data amount transferred by each of the plurality of bus masters;
a plurality of data transfer amount setting units operable to set reference data transfer amount predetermined for each of the plurality of bus masters; and
a plurality of comparing units operable to compare the accumulated data transfer amount with the reference data transfer amount for each of the plurality of bus masters,
wherein said plurality of comparing units generate, as the control information, information indicative that the prescribed data amount has been transferred, every time when the accumulated data transfer amount reaches the reference data transfer amount, thereby notifying said bus assignment deciding unit of the generated control information, and
wherein said bus assignment deciding unit changes the bus arbitration algorithm, based on the notified control information, thereby performing new bus arbitration.

7. The bus arbitrating device as defined in claim 6, wherein each of said plurality of data transfer amount measuring units, each of said plurality of data transfer amount setting units and each of said plurality of comparing units are respectively installed corresponding to each of the plurality of bus masters, in a one-to-one correspondence manner.

8. The bus arbitrating device as defined in claim 6, wherein said bus assignment deciding unit selects, based on the notified control information, one of a plurality of bus arbitration algorithms prepared in advance, thereby performing new bus arbitration using the selected bus arbitration algorithm.

9. The bus arbitrating device as defined in claim 8, wherein the bus arbitration algorithm selected by said bus assignment deciding unit is a fixed-priority scheduling.

10. The bus arbitrating device as defined in claim 8, wherein, when said bus assignment deciding unit selects the fixed-priority scheduling as the bus arbitration algorithm, said bus assignment deciding unit, based on the notified control information, prohibits bus use by a bus master for which the accumulated data transfer amount has reached the reference data transfer amount, the bus master being one of the plurality of bus masters.

11. The bus arbitrating device as defined in claim 8, wherein, when said bus assignment deciding unit selects the fixed-priority scheduling as the bus arbitration algorithm, said bus assignment deciding unit, based on the notified control information, lowers the priority in bus use by a bus master for which the accumulated data transfer amount has reached the reference data transfer amount, the bus master being one of the plurality of bus masters.

12. The bus arbitrating device as defined in claim 8, wherein, when said bus assignment deciding unit selects the fixed-priority scheduling as the bus arbitration algorithm, said bus assignment deciding unit, based on the notified control information, raises the priority in bus use by a bus master for which the accumulated data transfer amount has reached the reference data transfer amount, the bus master being one of the plurality of bus masters.

13. The bus arbitrating device as defined in claim 8, wherein the bus arbitration algorithm selected by said bus assignment deciding unit is a round-robin scheduling.

14. The bus arbitrating device as defined in claim 8, wherein, when said bus assignment deciding unit selects the round-robin scheduling as the bus arbitration algorithm, said bus assignment deciding unit, based on the notified control information, prohibits bus use by a bus master for which the accumulated data transfer amount has reached the reference data transfer amount, the bus master being one of the plurality of bus masters.

15. The bus arbitrating device as defined in claim 1, wherein said measurement control unit comprising:
a plurality of data transfer time measuring units operable to measure, as the bus arbitration judgment amount, necessary data transfer time indicative of time consumed in data transfer by each of the plurality of bus masters;
a plurality of data transfer time setting units operable to set reference data transfer time predetermined for each of the plurality of bus masters; and
a plurality of comparing units operable to compare the necessary data transfer time with the reference data transfer time for each of the plurality of bus masters,
wherein said plurality of comparing units generate, as the control information, information indicative that the prescribed data transfer time has been consumed, every time when the necessary data transfer time reaches the reference data transfer time, thereby notifying said bus assignment deciding unit of the generated control information, and
wherein said bus assignment deciding unit changes the bus arbitration algorithm, based on the notified control information, thereby performing new bus arbitration.

16. The bus arbitrating device as defined in claim 15, wherein each of said plurality of data transfer time measuring units, each of said plurality of data transfer time setting units and each of said plurality of comparing units are respectively installed, corresponding to each of the plurality of bus masters in a one-to-one correspondence manner.

17. The bus arbitrating device as defined in claim 15, wherein said bus assignment deciding unit selects, based on the notified control information, one of a plurality of bus arbitration algorithms prepared in advance, thereby performing new bus arbitration with the selected bus arbitration algorithm.

18. The bus arbitrating device as defined in claim 14, wherein the bus arbitration algorithm selected by said bus assignment deciding unit is a fixed-priority scheduling.

19. The bus arbitrating device as defined in claim 17, wherein, when said bus assignment deciding unit selects the fixed-priority scheduling as the bus arbitration algorithm, said bus assignment deciding unit, based on the notified control information, prohibits bus use by a bus master for which the necessary data transfer time has reached the reference data transfer time, the bus master being one of the plurality of bus masters.

20. The bus arbitrating device as defined in claim 17, wherein, when said bus assignment deciding unit selects the fixed-priority scheduling as the bus arbitration algorithm, said bus assignment deciding unit, based on the notified control information, lowers the priority in bus use by a bus master for which the necessary data transfer time has reached the reference data transfer time, the bus master being one of the plurality of bus masters.

21. The bus arbitrating device as defined in claim 17, wherein, when said bus assignment deciding unit selects the fixed-priority scheduling as the bus arbitration algorithm, said bus assignment deciding unit, based on the notified control information, raises the priority in bus use by a bus master for which the necessary data transfer time has reached the reference data transfer time, the bus master being one of the plurality of bus masters.

22. The bus arbitrating device as defined in claim 17, wherein the bus arbitration algorithm selected by said bus assignment deciding unit is a round-robin scheduling.

23. The bus arbitrating device as defined in claim 17, wherein, when said bus assignment deciding unit selects the round-robin scheduling as the bus arbitration algorithm, said bus assignment deciding unit, based on the notified control information, prohibits bus use by a bus master for which the necessary data transfer time has reached the reference data transfer time, the bus master being one of the plurality of bus masters.

24. A bus arbitrating method for arbitrating data transfer requests in a system including a bus and a plurality of bus masters which are connected to the bus and issue the data transfer requests, said bus arbitrating method comprising:
a measurement control step of measuring bus arbitration judgment amount; and
a bus assignment deciding step of arbitrating data transfer requests among the plurality of bus masters, based on a predetermined bus arbitration algorithm,
wherein said measurement control step includes measuring, as the bus arbitration judgment amount, at least one of: system operating time of the system; accumulated data transfer amount indicative of each accumulation of data amount transferred by each of the plurality of bus masters; and necessary data transfer time indicative of time consumed in data transfer by each of the plurality of bus masters,
wherein said measurement control step further includes generating control information when the measured bus arbitration judgment amount satisfies a prescribed condition, and
wherein said bus assignment deciding step includes changing the bus arbitration algorithm, based on the control information generated in said measurement control step, thereby performing new bus arbitration.

25. The bus arbitrating method as defined in claim 24, wherein said measurement control step comprises:
a timing step of timing the system operating time as the bus arbitration judgment amount;
a time period setting step of setting a time period corresponding to a prescribed time; and
a comparing step of comparing the system operating time with the time period,
wherein said comparing step includes generating, as the control information, information indicative that the prescribed time has elapsed, every time when the system operating time passes the time period, and
wherein said bus assignment deciding step includes changing the bus arbitration algorithm, based on the control information generated in said comparing step, thereby performing new bus arbitration.

26. The bus arbitrating method as defined in claim 25, wherein said bus assignment deciding step includes selecting one of a plurality of bus arbitration algorithms, based on the control information generated in said comparing step, thereby performing new bus arbitration with the selected bus arbitration algorithm.

27. The bus arbitrating method as defined in claim 24, wherein said measurement control step comprises:
a data transfer amount measuring step of measuring accumulated data transfer amount as the bus arbitration judgment amount, the accumulated data transfer amount being each accumulation of data amount transferred by each of the plurality of bus masters;
a data transfer amount setting step of setting reference data transfer amount predetermined for each of the plurality of bus masters; and
a comparing step of comparing the accumulated data transfer amount with the reference data transfer amount,
wherein said comparing step includes generating, as the control information, information indicative that the prescribed data amount has been transferred, every time when the accumulated data transfer amount reaches the reference data transfer amount, and
wherein said bus assignment deciding step includes changing the bus arbitration algorithm, based on the control information generated in said comparing step, thereby performing new bus arbitration with the changed bus arbitration algorithm.

28. The bus arbitrating method as defined in claim 27, wherein said bus assignment deciding step includes selecting one of a plurality of bus arbitration algorithms, based on the control information generated in said comparing step, thereby performing new bus arbitration with the selected bus arbitration algorithm.

29. The bus arbitrating method as defined in claim 27, wherein said bus assignment deciding step includes selecting, based on the control information generated in said comparing step, a bus arbitration algorithm that prohibits bus use by a bus master for which the accumulated data transfer amount has reached the reference data transfer amount, the bus master being one of the plurality of bus masters.

30. The bus arbitrating method as defined in claim 27, wherein said bus assignment deciding step includes selecting, based on the control information generated in said comparing step, a bus arbitration algorithm that lowers the priority in bus use by a bus master for which the accumulated data transfer amount has reached the reference data transfer amount, the bus master being one of the plurality of bus masters.

31. The bus arbitrating method as defined in claim 27, wherein said bus assignment deciding step includes selecting, based on the control information generated in said comparing step, a bus arbitration algorithm that raises the priority in bus use by a bus master for which the accumulated data transfer amount has reached the reference data transfer amount, the bus master being one of the plurality of bus masters.

32. The bus arbitrating method as defined in claim 24, wherein said measurement control step comprises:
a data transfer time measuring step of measuring necessary data transfer time indicative of time consumed in data transfer by each of the plurality of bus masters, as the bus arbitration judgment amount;
a data transfer time setting step of setting reference data transfer time prescribed for each of the plurality of bus masters; and
a comparing step of comparing the necessary data transfer time with the reference data transfer time for each of the plurality of bus masters,
wherein said comparing step includes generating, as the control information, information indicative that the prescribed data transfer time has been consumed, every time when the necessary data transfer time reaches the reference data transfer time, and
wherein said bus assignment deciding step includes changing the bus arbitration algorithm, based on the control information generated in said comparing step, thereby performing new bus arbitration with the changed bus arbitration algorithm.

33. The bus arbitrating method as defined in claim 32, wherein said bus assignment deciding step includes selecting one of a plurality of bus arbitration algorithms prepared in advance, based on the control information generated in said comparing step, thereby performing new bus arbitration with the selected bus arbitration algorithm.

34. The bus arbitrating method as defined in claim 32, wherein said bus assignment deciding step includes selecting, based on the control information generated in said comparing step, a bus arbitration algorithm that prohibits bus use by a bus master for which the necessary data transfer time has reached the reference data transfer time, the bus master being one of the plurality of bus masters.

35. The bus arbitrating method as defined in claim 32, wherein said bus assignment deciding step includes selecting, based on the control information generated in said comparing step, a bus arbitration algorithm that lowers the priority in bus use by a bus master for which the necessary data transfer time has reached the reference data transfer time, the bus master being one of the plurality of bus masters.

36. The bus arbitrating method as defined in claim 32, wherein said bus assignment deciding step includes selecting, based on the control information generated in said comparing step, a bus arbitration algorithm that raises the priority in bus use by a bus master for which the necessary data transfer time has reached the reference data transfer time, the bus master being one of the plurality of bus masters.
